(19) United States
(12) Patent Application Publication
(10) Pub. No.: US 2013/0113846 A1
(43) Pub. Date: May 9, 2013

(54) PLASMA DISPLAY DEVICE, PLASMA DISPLAY SYSTEM, AND METHOD OF DRIVING A PLASMA DISPLAY PANEL

(71) Applicants: Takahiko Origuchi, Osaka (JP); Kazuaki Sakata, Osaka (JP); Naoyuki Tomioka, Osaka (JP); Mitsuhiro Ishizuka, Osaka (JP)

(72) Inventors: Takahiko Origuchi, Osaka (JP); Kazuaki Sakata, Osaka (JP); Naoyuki Tomioka, Osaka (JP); Mitsuhiro Ishizuka, Osaka (JP)

(73) Assignee: PANASONIC CORPORATION, Osaka (JP)

(21) Appl. No.: 13/703,291

(22) PCT Filed: Jul. 21, 2011
(86) PCT No.: PCT/JP2011/004112

§ 371 Date: Dec. 10, 2012

(30) Foreign Application Priority Data
Jul. 23, 2010 (JP) 2010-165657

(51) Int. Cl. G09G 3/28

(52) U.S. Cl. CPC G09G 3/28
USPC 345/690; 345/63

(57) ABSTRACT

High image display quality is achieved when a 3D image is displayed on a plasma display panel (10). For this purpose, a driver circuit includes sustain pulse generation circuits (60) and (80), control signal generation circuit (45) for generating a shutter opening/closing timing signal and a control signal for controlling sustain pulse generation circuits (60) and (80), all-cell light-emitting rate detecting circuit (46) for detecting the all-cell light-emitting rate in each subfield, and partial light-emitting rate detecting circuit (47) for detecting the partial light-emitting rate in each of a plurality of regions set in an image display region of plasma display panel (10) in each subfield. The driver circuit corrects the number of sustain pulses to be generated set based on the image signal and luminance weight in each of the subfields in response to the all-cell light-emitting rate and the partial light-emitting rate.

### TECHNICAL FIELD

The present invention relates to a plasma display apparatus, a plasma display system, and a driving method of a plasma display panel that allow three-dimensional vision using shutter glasses of a three-dimensional image formed of a right-eye image and left-eye image that are alternately displayed on the plasma display panel.

### BACKGROUND ART

An alternating-current surface discharge type panel typical as a plasma display panel (hereinafter referred to as “panel”) has many discharge cells between a front substrate and a rear substrate that are faced to each other. The front substrate has the following elements:
a plurality of display electrode pairs disposed in parallel on a front glass substrate; and
a dielectric layer and protective layer disposed so as to cover the display electrode pairs.
   Here, each display electrode pair is formed of a pair of scan electrode and sustain electrode.

The rear substrate has the following elements:
a plurality of data electrodes disposed in parallel on a rear glass substrate;
a dielectric layer disposed so as to cover the data electrodes;
a plurality of barrier ribs disposed on the dielectric layer in parallel with the data electrodes; and
phosphor layers disposed on the surface of the dielectric layer and on side surfaces of the barrier ribs.

The front substrate and rear substrate are faced to each other so that the display electrode pairs and the data electrodes three-dimensionally intersect, and are sealed. Discharge gas containing xenon with a partial pressure ratio of 5%, for example, is filled into a discharge space in the sealed product. Discharge cells are disposed in intersecting parts of the display electrode pairs and the data electrodes. In the panel having this structure, ultraviolet rays are emitted by gas discharge in each discharge cell. The ultraviolet rays excite respective phosphors of red (R), green (G), and blue (B) to emit light, and thus provide color image display.

A subfield method is generally used as a method of driving the panel. In this subfield method, one field is divided into a plurality of subfields, and light is emitted or light is not emitted in each discharge cell in each subfield, thereby performing gradation display. Each subfield has an initializing period, an address period, and a sustain period.

In the initializing period, an initializing operation of applying an initializing waveform to each scan electrode, and causing initializing discharge in each discharge cell is performed. Thus, wall charge required for a subsequent address operation is produced in each discharge cell, and a priming particle (an excitation particle for causing discharge) for stably causing address discharge is generated.

In the address period, a scan pulse is sequentially applied to scan electrodes, and an address pulse is selectively applied to data electrodes based on an image signal to be displayed. Thus, address discharge is caused between the scan electrode and the data electrode of the discharge cell to emit light, thereby producing wall charge in the discharge cell (hereinafter, this operation is also collectively referred to as “address”).

In a sustain period, as many sustain pulses as a number based on the luminance weight determined for each subfield are alternately applied to the display electrode pairs formed of the scan electrodes and the sustain electrodes. Thus, sustain discharge is caused in the discharge cell having undergone address discharge, thereby emitting light in the phosphor layer of this discharge cell (hereinafter, light emission by sustain discharge in a discharge cell is referred to as “lighting”, and no light emission is referred to as “no-lighting”). Thus, light is emitted in each discharge cell at a luminance corresponding to the luminance weight. Thus, light is emitted at a luminance corresponding to the gradation value of an image signal in each discharge cell of the panel, and an image is displayed on the image display region of the panel.

One of important factors for improving the image display quality on the panel is improvement in contrast. As one of subfield methods, a driving method for improving the contrast ratio by minimizing light emission that is not related to the gradation display is disclosed.

In this driving method, in the initializing period of one of a plurality of subfields constituting one field, an initializing operation of causing initializing discharge in all discharge cells is performed. In the initializing periods of other subfields, an initializing operation of selectively causing initializing discharge in the discharge cell that has undergone sustain discharge in the sustain period of the immediately preceding subfield is performed.

The luminance (hereinafter, referred to as “luminance of black level”) in a black displaying region that does not cause sustain discharge is varied by light emission that is not related to the image display, for example light emission caused by initializing discharge. In the above-mentioned driving method, the light emission in the black displaying region is only weak light emission when the initializing operation is performed in all discharge cells. As a result, the luminance of black level can be reduced and an image of sharp contrast can be displayed (for example, Patent Literature 1).

Some plasma display apparatuses using this panel have a function of displaying a three-dimensional image for three-dimensional vision that is formed of a right-eye image and a left-eye image. Hereinafter, three dimension is referred to as “3D”, and a three-dimensional image is referred to as “3D image”. A function of displaying a three-dimensional image is referred to as “3D image display function”. An image display apparatus having a 3D image display function is referred to as “3D image display apparatus”. A normal image having no differentiation between the right-eye and left-eye is referred to as “2D image”.

One 3D image is constituted by one right-eye image and one left-eye image. In this plasma display apparatus, when the 3D image is displayed on the panel, the right-eye image and left-eye image are alternately displayed on the panel.

A user views the 3D image displayed on the panel using special glasses called shutter glasses. In the shutter glasses, right and left shutters alternately open and close synchronously with each of a field for displaying the right-eye image and a field for displaying the left-eye image.

The shutter glasses have a right-eye shutter and a left-eye shutter. In a period in which the right-eye image is displayed on the panel, the right-eye shutter is opened (visible light is transmitted) and the left-eye shutter is closed (visible light is blocked). In a period in which the left-eye image is displayed, the left-eye shutter is opened and the right-eye shutter is closed. Thus, the user can observe the right-eye image only with the right eye and the left-eye image only with the left eye, and can three-dimensionally view the 3D image displayed on the panel.

As one of methods of three-dimensionally viewing a 3D image using a plasma display apparatus, for example, a method is disclosed in which a plurality of subfields is classified into a subfield group for displaying right-eye images and a subfield group for displaying left-eye images, and the shutters of the shutter glasses are opened or closed synchronously with the start of the address period of the first subfield of each subfield group (for example, Patent Literature 2).

When the driving impedance differs between display electrode pairs, voltage drop of the driving voltage differs between the display electrode pairs. In this case, a plurality of regions between which emission luminance differs though image signals have the same luminance can occur in an image display region of the panel. A technology is therefore disclosed where the lighting pattern is made to differ between subfields in one field when the driving impedance differs between display electrode pairs (for example, Patent Literature 3).

As the screen of the panel is enlarged and the definition is enhanced, further improvement in image display quality is demanded, and high image display quality is demanded also in a plasma display apparatus having a 3D image display function.

Phosphors used in the panel, however, have afterglow characteristics depending on the materials of the phosphors. The afterglow means a phenomenon where the phosphors continue light emission even after the completion of discharge. There is a phosphor material having a characteristic where afterglow continues for several milliseconds even after the completion of sustain discharge. Thus, even after the period for displaying a right-eye image (or left-eye image) is finished, the right-eye image (or left-eye image) is displayed on the panel in response to the afterglow time. Hereinafter, such a phenomenon is referred to as “afterimage”.

When a left-eye image is displayed on the panel before the afterimage of a right-eye image disappears, a phenomenon where the right-eye image mixes into the left-eye image occurs. Similarly, when a right-eye image is displayed on the panel before the afterimage of a left-eye image disappears, a phenomenon where the left-eye image mixes into the right-eye image occurs. Hereinafter, such a phenomenon is referred to as “crosstalk”. When crosstalk occurs, the quality as a 3D image reduces.

As the screen of the panel is enlarged and the definition is enhanced, the driving impedance of the panel is apt to increase. In such a panel, the difference in driving impedance occurring between the display electrode pairs is apt to increase and the difference in voltage drop of the driving voltage is also apt to increase.

When the driving impedance differs between display electrode pairs, emission luminance caused by one sustain discharge differs between subfields. When the panel is driven by the subfield method, as discussed above, one field period is divided into a plurality of subfields, and gradation display is performed by combination of the subfields to emit light. Therefore, when the emission luminance caused by one sustain discharge differs between subfields, the linearity of the gradation can be damaged.

In the panel where the driving impedance is increased by the enlargement of the screen of the panel and the enhancement of the definition, the difference in driving impedance between subfields is apt to increase and the difference in emission luminance is apt to occur between subfields, so that the linearity of the gradation is apt to be damaged.

### CITATION LIST

### Patent Literature

PLT 1 Unexamined Japanese Patent Publication No. 2000-242224
PLT 2 Unexamined Japanese Patent Publication No. 2000-112428
PLT 3 Unexamined Japanese Patent Publication No. 2006-184843

### SUMMARY OF THE INVENTION

The present invention provides a plasma display apparatus including a panel and a driver circuit. The panel has a plurality of discharge cells each of which includes a display electrode pair formed of a scan electrode and a sustain electrode. The driver circuit forms one field using a plurality of subfields having a sustain period in which a luminance weight is set. The driver circuit displays an image on the panel by alternately repeating a right-eye field for displaying a right-eye image signal and a left-eye field for displaying a left-eye image signal based on an image signal having the right-eye image signal and the left-eye image signal. The driver circuit includes the following elements:
a sustain pulse generation circuit that generates as many sustain pulses as the number corresponding to the luminance weight in the sustain period, and alternately applies them to the scan electrodes and sustain electrodes of the display electrode pairs;
a control signal generation circuit for generating a shutter opening/closing timing signal and a control signal that controls the sustain pulse generation circuit;
an all-cell light-emitting rate detecting circuit for detecting, as all-cell light-emitting rate, the ratio of the number of discharge cells to be lit to the total number of discharge cells in the image display region of the panel; and
a partial light-emitting rate detecting circuit that divides the image display region of the panel into a plurality of regions and detects, as partial light-emitting rate, the ratio of the number of discharge cells to be lit to the total number of discharge cells in each subfield in each of the regions.
   Here, the shutter opening/closing timing signal includes the following signals:
a right-eye timing signal that becomes ON when a right-eye field is displayed on the panel and becomes OFF when a left-eye field is displayed; and
a left-eye timing signal that becomes ON when a left-eye field is displayed and becomes OFF when a right-eye field is displayed.
   Then, the driver circuit corrects the number of sustain pulses to be generated in each of the subfields in response to the all-cell light-emitting rate and partial light-emitting rates, and the sustain pulse generation circuit generates as many sustain pulses as the corrected number.

Thus, for a user who views a 3D image through shutter glasses, the plasma display apparatus having a 3D image display function displays a 3D image where crosstalk occurring between a right-eye image and left-eye image is reduced while the linearity of the gradation in the display image is kept, thereby improving the image display quality.

The driver circuit of the plasma display apparatus of the present invention may be configured to correct the number of sustain pulses to be generated in response to the all-cell light-emitting rate and the partial light-emitting rates in subfields other than the first subfield and the final subfield of a field.

The driver circuit of the plasma display apparatus of the present invention may be configured to set the first subfield to have the smallest luminance weight and set the final subfield to have the same luminance weight as that of the first subfield or have the second-smallest luminance weight.

The driver circuit of the plasma display apparatus of the present invention may have the following configuration:
the driver circuit calculates the average value of the partial light-emitting rates in the regions where the partial light-emitting rates exceed a predetermined threshold in each subfield; and
the driver circuit corrects the number of sustain pulses to be generated in response to the all-cell light-emitting rate and the average value of the partial light-emitting rates in the subfields other than first subfield and the final subfield of the field.

The driver circuit of the plasma display apparatus of the present invention may be configured to set one display electrode pair as one region and detect the partial light-emitting rate in each of the display electrode pairs.

The driver circuit of the plasma display apparatus of the present invention may have the following configuration:
the driver circuit generates a plurality of sustain pulses between which the length of at least one of the rising period and falling period differs from those of another sustain pulse; and
the driver circuit selects one driving pattern from a plurality of driving patterns, each of which has a different combination of the sustain pulses to be generated, in response to the all-cell light-emitting rate and the partial light-emitting rates, and generates the sustain pulses.

The present invention provides a plasma display system having a plasma display apparatus and shutter glasses. The plasma display apparatus includes a panel and a driver circuit. The panel has a plurality of discharge cells each of which includes a display electrode pair formed of a scan electrode and a sustain electrode. The driver circuit forms one field using a plurality of subfields having a sustain period in which a luminance weight is set. The driver circuit displays an image on the panel by alternately repeating a right-eye field for displaying a right-eye image signal and a left-eye field for displaying a left-eye image signal based on an image signal having the right-eye image signal and the left-eye image signal. The shutter glasses include a right-eye shutter and a left-eye shutter that can be independently opened or closed, and control the opening/closing of the shutters in response to the shutter opening/closing timing signal generated by the control signal generation circuit.

The driver circuit includes the following elements:
a sustain pulse generation circuit that generates as many sustain pulses as the number corresponding to the luminance weight in the sustain period, and alternately applies them to the scan electrodes and sustain electrodes of the display electrode pairs;
a control signal generation circuit for generating a shutter opening/closing timing signal and a control signal that controls the sustain pulse generation circuit;
an all-cell light-emitting rate detecting circuit for detecting, as all-cell light-emitting rate, the ratio of the number of discharge cells to be lit to the total number of discharge cells in the image display region of the panel; and
a partial light-emitting rate detecting circuit that divides the image display region of the panel into a plurality of regions and detects, as a partial light-emitting rate, the ratio of the number of discharge cells to be lit to the total number of discharge cells in each of the regions in each subfield.
   Here, the shutter opening/closing timing signal includes the following signals:
a right-eye timing signal that becomes ON when a right-eye field is displayed on the panel and becomes OFF when a left-eye field is displayed; and
a left-eye timing signal that becomes ON when a left-eye field is displayed and becomes OFF when a right-eye field is displayed.
   Then, the driver circuit corrects the number of sustain pulses to be generated in response to the all-cell light-emitting rate and the partial light-emitting rates in subfields other than the first subfield and the final subfield of a field, and the sustain pulse generation circuit generates as many sustain pulses as the corrected number.

Thus, for a user who views a 3D image through the shutter glasses, the plasma display apparatus having a 3D image display function displays a 3D image where crosstalk occurring between a right-eye image and left-eye image is reduced while the linearity of the gradation in the display image is kept, thereby improving the image display quality.

The present invention provides a driving method of a panel having a plurality of discharge cells each of which includes a display electrode pair formed of a scan electrode and a sustain electrode. In this driving method, one field is constituted by a plurality of subfields having a sustain period in which a luminance weight is set. An image is displayed on the panel by alternately repeating a right-eye field for displaying a right-eye image signal and a left-eye field for displaying a left-eye image signal based on an image signal having the right-eye image signal and the left-eye image signal. The ratio of the number of discharge cells to be lit to the total number of discharge cells in the image display region of the panel is detected as the all-cell light-emitting rate in each subfield. The image display region of the plasma display panel is divided into a plurality of regions, and the ratio of the number of discharge cells to be lit to the total number of discharge cells is detected as the partial light-emitting rate in each subfield in each of the regions. The number of sustain pulses to be generated is corrected in response to the all-cell light-emitting rate and the partial light-emitting rates in subfields other than the first subfield and the final subfield of a field.

Thus, for a user who views a 3D image through the shutter glasses, the plasma display apparatus having a 3D image display function displays a 3D image where crosstalk occurring between a right-eye image and left-eye image is reduced while the linearity of the gradation in the display image is kept, thereby improving the image display quality.

### BRIEF DESCRIPTION OF DRAWINGS

FIG. 1 is an exploded perspective view showing a structure of a panel used in a plasma display apparatus in accordance with a first exemplary embodiment of the present invention.

FIG. 2 is an electrode array diagram of the panel used in the plasma display apparatus in accordance with the first exemplary embodiment of the present invention.

FIG. 3 is a diagram for schematically showing circuit blocks of the plasma display apparatus and a plasma display system in accordance with the first exemplary embodiment of the present invention.

FIG. 4 is a circuit diagram showing one configuration example of a sustain pulse generation circuit in accordance with the first exemplary embodiment of the present invention.

FIG. 5 is a diagram for schematically showing a driving voltage waveform to be applied to each electrode of the panel used in the plasma display apparatus in accordance with the first exemplary embodiment of the present invention.

FIG. 6 is a waveform chart for schematically showing a driving voltage waveform applied to each electrode of the panel used in the plasma display apparatus and an opening/closing operation of shutter glasses in accordance with the first exemplary embodiment of the present invention.

FIG. 7 is a diagram for schematically showing a subfield structure and an open/close state of a right-eye shutter and a left-eye shutter when a 3D image is displayed on the plasma display apparatus in accordance with the first exemplary embodiment of the present invention.

FIG. 8A is a diagram for schematically showing the light emission state of the panel when the lit region is set as 80% of the image display region of the panel.

FIG. 8B is a diagram for schematically showing the light emission state of the panel when the lit region is set as 20% of the image display region of the panel.

FIG. 9A is a diagram for schematically showing the light emission state of the panel when the lit region is set as 50% of the image display region of the panel.

FIG. 9B is a diagram for schematically showing the light emission state of the panel when the lit region is set as 25% of the image display region of the panel.

FIG. 10 is a diagram for schematically showing the measurement of emission luminance performed for setting a correction coefficient in accordance with the first exemplary embodiment of the present invention.

FIG. 11 is a diagram showing one example of the correction coefficients in accordance with the first exemplary embodiment of the present invention.

FIG. 12 is a diagram showing one example of circuit blocks of a number-of-sustain-pulses correcting section in accordance with the first exemplary embodiment of the present invention.

FIG. 13 is a circuit block diagram of a plasma display apparatus in accordance with a second exemplary embodiment of the present invention.

FIG. 14 is a diagram showing one example of the relationship between the all-cell light-emitting rate, the average value of the partial light-emitting rates, and switching of the driving patterns in accordance with the second exemplary embodiment of the present invention.

FIG. 15 is a diagram for schematically showing the waveform of the sustain pulses generated in a first driving pattern in accordance with the second exemplary embodiment of the present invention.

FIG. 16 is a diagram for schematically showing the waveform of the sustain pulses generated in a second driving pattern in accordance with the second exemplary embodiment of the present invention.

FIG. 17 is a diagram for schematically showing the waveform of the sustain pulses generated in a third driving pattern in accordance with the second exemplary embodiment of the present invention.

FIG. 18 is a diagram for schematically showing the waveform of the sustain pulses generated in a fourth driving pattern in accordance with the second exemplary embodiment of the present invention.

FIG. 19 is a diagram for schematically showing the waveform of the sustain pulses generated in a fifth driving pattern in accordance with the second exemplary embodiment of the present invention.

FIG. 20 is a diagram for schematically showing the waveform of the sustain pulses generated in a sixth driving pattern in accordance with the second exemplary embodiment of the present invention.

### DESCRIPTION OF EMBODIMENTS

A plasma display apparatus and a plasma display system in accordance with exemplary embodiments of the present invention will be described hereinafter with reference to the accompanying drawings.

### First Exemplary Embodiment

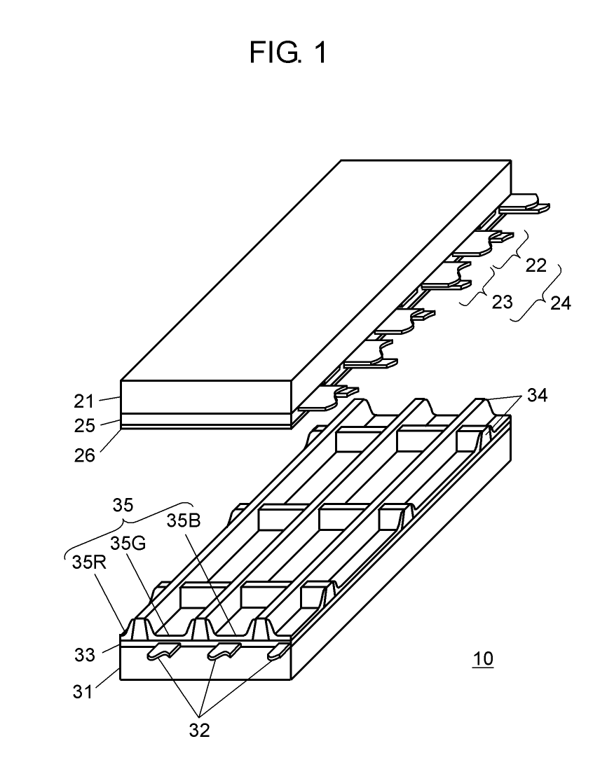

FIG. 1 is an exploded perspective view showing the structure of panel 10 used in a plasma display apparatus in accordance with a first exemplary embodiment of the present invention. A plurality of display electrode pairs 24 formed of scan electrodes 22 and sustain electrodes 23 is disposed on glass-made front substrate 21. Dielectric layer 25 is formed so as to cover scan electrodes 22 and sustain electrodes 23, and protective layer 26 is formed on dielectric layer 25.

Protective layer 26 is made of a material mainly made of magnesium oxide (MgO) in order to reduce the discharge start voltage in a discharge cell. The magnesium oxide has been used as a material of the panel, and has a large secondary electron emission coefficient and high durability when neon (Ne) gas and xenon (Xe) gas are filled.

A plurality of data electrodes 32 is formed on rear substrate 31, dielectric layer 33 is formed so as to cover data electrodes 32, and mesh barrier ribs 34 are formed on dielectric layer 33. Phosphor layer 35R for emitting light of red color (R), phosphor layer 35G for emitting light of green color (G), and phosphor layer 35B for emitting light of blue color (B) are formed on the side surfaces of barrier ribs 34 and on dielectric layer 33. Hereinafter, phosphor layer 35R, phosphor layer 35G, and phosphor layer 35B are collectively denoted as phosphor layers 35.

In the present exemplary embodiment, BaMgAl₁₀O₁₇:Eu is used as the blue phosphor, Zn₂SiO₄:Mn is used as the green phosphor, and (Y,Gd)BO₃:Eu is used as the red phosphor. In the present invention, the phosphors forming phosphor layers 35 are not limited to the above-mentioned phosphors.

The time constant representing the time required for attenuation of the afterglow of each phosphor depends on the phosphor material. The time constant of the blue phosphor is 1 msec or shorter, that of the green phosphor is about 2 to 5 msec, and that of the red phosphor is about 3 to 4 msec. In the present exemplary embodiment, for example, the time constant of phosphor layer 35B is about 0.1 msec, and those of phosphor layer 35G and phosphor layer 35R are about 3 msec. Each time constant is defined as the time period after the completion of discharge until the afterglow attenuates to about 10% of the emission luminance (peak luminance) during discharge.

Front substrate 21 and rear substrate 31 are faced to each other so that display electrode pairs 24 cross data electrodes 32 with a micro discharge space sandwiched between them, and the outer peripheries of them are sealed by a sealing material such as glass frit. The discharge space is filled with mixed gas of neon and xenon as discharge gas, for example.

The discharge space is partitioned into a plurality of sections by barrier ribs 34. Discharge cells are formed in the intersecting parts of display electrode pairs 24 and data electrodes 32.

Then, discharge is caused in the discharge cells, and light is emitted (lighting in the discharge cells) in phosphor layers 35 of them, thereby displaying a color image on panel 10.

In panel 10, one pixel is formed of three consecutive discharge cells arranged in the extending direction of display electrode pairs 24. The three discharge cells are a discharge cell for emitting light of red color (R), a discharge cell for emitting light of green color (G), and a discharge cell for emitting light of blue color (B).

The structure of panel 10 is not limited to the above-mentioned one, but may be a structure having striped barrier ribs, for example.

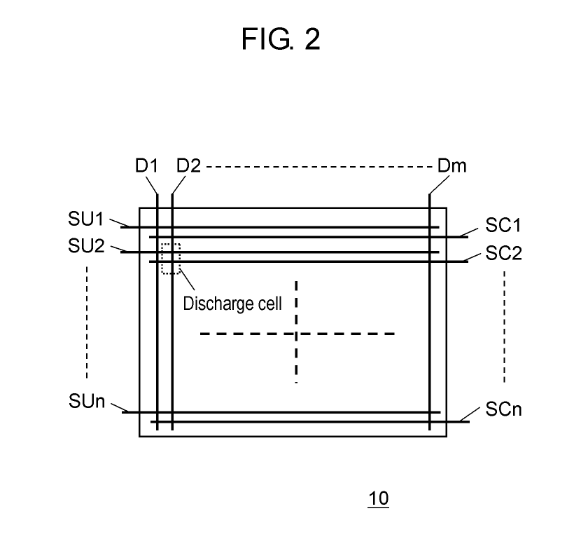

FIG. 2 is an electrode array diagram of panel 10 used in the plasma display apparatus in accordance with the first exemplary embodiment of the present invention. Panel 10 has n scan electrode SC1 through scan electrode SCn (scan electrodes 22 in FIG. 1) and n sustain electrode SU1 through sustain electrode SUn (sustain electrodes 23 in FIG. 1) both extended horizontally (row direction), and m data electrode D1 through data electrode Dm (data electrodes 32 in FIG. 1) extended vertically (column direction). A discharge cell is formed in the part where a pair of scan electrode SCi (i is 1 through n) and sustain electrode SUi intersect with one data electrode Dj (j is 1 through m). In other words, on one display electrode pair 24, m discharge cells are formed and m/3 pixels are formed. Thus, m×n discharge cells are formed in the discharge space, the region having m×n discharge cells defines the image display region of panel 10. In the panel where the number of pixels is 1920×1080, for example, m is 1920×3 and n is 1080.

A red phosphor is applied as phosphor layer 35R to a discharge cell having data electrode Dp (p=3×q−2: q is an integer other than 0 and is m/3 or smaller), a green phosphor is applied as phosphor layer 35G to a discharge cell having data electrode Dp+1, and a blue phosphor is applied as phosphor layer 35B to a discharge cell having data electrode Dp+2.

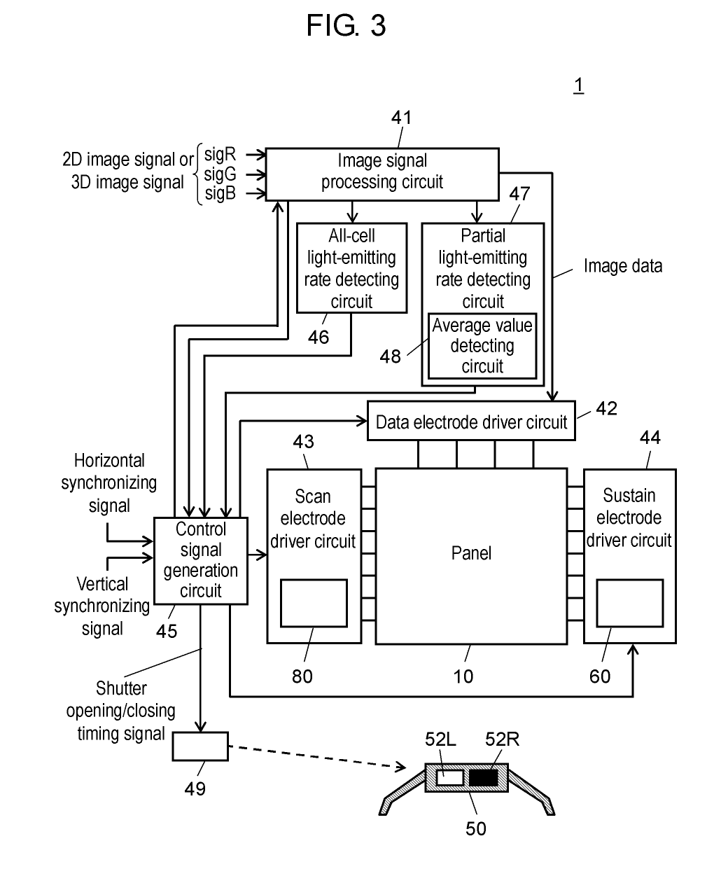

FIG. 3 is a diagram for schematically showing circuit blocks of plasma display apparatus 1 and a plasma display system in accordance with the first exemplary embodiment of the present invention. The plasma display system of the first exemplary embodiment includes, as components, plasma display apparatus 1 and shutter glasses 50.

Plasma display apparatus 1 includes panel 10 having a plurality of discharge cells each of which includes scan electrode 22, sustain electrode 23, and data electrode 32, and a driver circuit for driving panel 10. The driver circuit has the following elements:
image signal processing circuit 41;
all-cell light-emitting rate detecting circuit 46
partial light-emitting rate detecting circuit 47
data electrode driver circuit 42;
scan electrode driver circuit 43;
sustain electrode driver circuit 44;
control signal generation circuit 45; and
a power supply circuit (not shown) for supplying power required for each circuit block.

The driver circuit drives panel 10 by one of 3D drive for displaying a 3D image on panel 10 by alternately repeating a right-eye field and a left-eye field based on a 3D image signal and 2D drive for displaying a 2D image on panel 10 based on a 2D image signal having no differentiation between the right-eye and left-eye. Plasma display apparatus 1 also includes timing signal output section 49. Timing signal output section 49 outputs, to shutter glasses 50, a shutter opening/closing timing signal for controlling the opening/closing of the shutters of shutter glasses 50 used by a user. Shutter glasses 50 are used by the user when a 3D image is displayed on panel 10, and the user can three-dimensionally view the 3D image by viewing the 3D image through shutter glasses 50.

Image signal processing circuit 41 receives a 2D image signal or 3D image signal, and assigns a gradation value to each discharge cell based on an input image signal. Then, image signal processing circuit 41 converts the gradation value into image data that indicates light emission or no light emission in each subfield (light emission and no light emission are made to correspond to digital signals, “1” and “0”). In other words, image signal processing circuit 41 converts the image signal in each field into image data that indicates light emission or no light emission in each subfield.

When an image signal input to image signal processing circuit 41 includes red primary color signal sigR, green primary color signal sigG, and blue primary color signal sigB, image signal processing circuit 41 assigns each gradation value of R, G, and B to each discharge cell based on primary color signal sigR, primary color signal sigG, and primary color signal sigB. When the input image signal includes a luminance signal (Y signal) and a chroma signal (C signal, R-Y signal and B-Y signal, or u signal and v signal), image signal processing circuit 41 calculates primary color signal sigR, primary color signal sigG, and primary color signal sigB based on the luminance signal and chroma signal, and then assigns each gradation value (gradation value represented in one field) of R, G, and B to each discharge cell. Image signal processing circuit 41 converts each gradation value of R, G, and B assigned to each discharge cell into image data that indicates light emission or no light emission in each subfield.

When the input image signal is a 3D image signal for 3D vision having a right-eye image signal and a left-eye image signal, and the 3D image signal is displayed on panel 10, the right-eye image signal and left-eye image signal are alternately input to image signal processing circuit 41 in each field. Therefore, image signal processing circuit 41 converts the right-eye image signal into right-eye image data, and converts the left-eye image signal into left-eye image data.

All-cell light-emitting rate detecting circuit 46 calculates the number of discharge cells to be lit in each subfield based on the image data of each subfield. All-cell light-emitting rate detecting circuit 46 detects, as “all-cell light-emitting rate”, the ratio of the number of discharge cells to be lit to the total number of discharge cells in the image display region of panel 10. All-cell light-emitting rate detecting circuit 46 outputs a signal indicating the detected all-cell light-emitting rate to control signal generation circuit 45.

Partial light-emitting rate detecting circuit 47 divides the image display region of panel 10 into a plurality of regions and detects, as “partial light-emitting rate”, the ratio of the number of discharge cells to be lit to the total number of discharge cells in each region in each subfield based on the image data of each subfield. Partial light-emitting rate detecting circuit 47 may be configured to detect the partial light-emitting rate while the region constituted by a plurality of scan electrodes 22 that is connected to one of integrated circuits (ICs) (hereinafter referred to as “scan ICs”) for driving scan electrodes 22 is set as one region, for example. In the present exemplary embodiment, however, the partial light-emitting rate is detected while the region constituted by the discharge cells that are formed on one display electrode pair 24 is set as one region.

Partial light-emitting rate detecting circuit 47 includes average value detecting circuit 48. Average value detecting circuit 48 compares the partial light-emitting rate detected by partial light-emitting rate detecting circuit 47 with a predetermined threshold. Hereinafter, the predetermined threshold is referred to as “partial light-emitting rate threshold”. Then, average value detecting circuit 48 calculates, in each subfield, the average value of the partial light-emitting rates in display electrode pairs 24 other than display electrode pairs 24 where the partial light-emitting rate is the partial light-emitting rate threshold or lower. In other words, average value detecting circuit 48 calculates the average value of the partial light-emitting rates in display electrode pairs 24 where the partial light-emitting rate exceeds the partial light-emitting rate threshold. Then, average value detecting circuit 48 outputs a signal that indicates the result to control signal generation circuit 45. For example, it is assumed that, in a certain subfield, 1080 display electrode pairs 24 are disposed on panel 10, and the partial light-emitting rates of 200 display electrode pairs 24 are the partial light-emitting rate threshold or lower. In this case, in the certain subfield, average value detecting circuit 48 calculates the average value of the partial light-emitting rates of 880 display electrode pairs 24 where the partial light-emitting rate exceeds the partial light-emitting rate threshold.

In the present exemplary embodiment, the partial light-emitting rate threshold is set at “0%”. The purpose of this setting is to omit display electrode pairs 24 where a discharge cell to be lit does not substantially occur from the object for which an average value of the partial light-emitting rates is calculated.

However, the partial light-emitting rate threshold of the present invention is not limited to the above-mentioned numerical value. Preferably, the partial light-emitting rate threshold is set at the optimal value based on the characteristics of panel 10 and the specification of plasma display apparatus 1.

In the present exemplary embodiment, a normalizing operation for percentage notation is performed when the all-cell light-emitting rate and partial light-emitting rates are calculated. However, the normalizing operation is not required. For example, the calculated number of discharge cells to be lit may be used instead of the all-cell light-emitting rate and partial light-emitting rates. Hereinafter, a discharge cell to be lit is referred to as “lit cell”, and a discharge cell that is not to be lit is referred to as “unlit cell”.

Control signal generation circuit 45 determines which of a 2D image signal and 3D image signal is input to plasma display apparatus 1 based on an input signal. Based on the determination result, control signal generation circuit 45 generates a control signal for controlling each driver circuit in order to display the 2D image or 3D image on panel 10.

Specifically, control signal generation circuit 45 determines whether the input signal to plasma display apparatus 1 is a 3D image signal or a 2D image signal based on the frequencies of the horizontal synchronizing signal and the vertical synchronizing signal of the input signal. Control signal generation circuit 45 determines that the input signal is a 2D image signal when the horizontal synchronizing signal is 33.75 kHz and the vertical synchronizing signal is 60 Hz, or determines that the input signal is a 3D image signal when the horizontal synchronizing signal is 67.5 kHz and the vertical synchronizing signal is 120 Hz, for example.

Based on horizontal synchronizing signal H, vertical synchronizing signal V, an output from all-cell light-emitting rate detecting circuit 46, and an output from partial light-emitting rate detecting circuit 47, control signal generation circuit 45 generates various control signals for controlling the operation of each circuit block. Then, control signal generation circuit 45 supplies the generated control signals to respective circuit blocks (data electrode driver circuit 42, scan electrode driver circuit 43, sustain electrode driver circuit 44, and image signal processing circuit 41).

When a determination signal for determining a 2D image signal or a 3D image signal is added to the input signal, control signal generation circuit 45 may determine which of a 2D image signal and 3D image signal is input based on the determination signal.

In the present exemplary embodiment, the number of sustain pulses to be generated is altered in response to the all-cell light-emitting rate and the average value of the partial light-emitting rates. Specifically, control signal generation circuit 45 temporarily sets the number of sustain pulses to be generated in each subfield based on the input image signal and the luminance weight set for each subfield. Then, control signal generation circuit 45 corrects the number of sustain pulses to be generated using a correction coefficient that is determined based on the all-cell light-emitting rate and the average value of the partial light-emitting rates. Thus, control signal generation circuit 45 alters the number of sustain pulses to be generated. For this purpose, control signal generation circuit 45 has a number-of-sustain-pulses correcting section (not shown) capable of correcting the number of sustain pulses to be generated based on the all-cell light-emitting rate and the average value of the partial light-emitting rates.

In the present exemplary embodiment, the number-of-sustain-pulses correcting section has a look-up table. A plurality of different correction coefficients is previously stored on the look-up table in association with the all-cell light-emitting rate and the partial light-emitting rates, and one of the correction coefficients can be read in response to the all-cell light-emitting rate and the average value of the partial light-emitting rates. The details of these configurations are described later. However, the present invention is not limited to these configurations. Any configuration may be employed as long as it performs the same operation.

Control signal generation circuit 45 outputs, to timing signal output section 49, a shutter opening/closing timing signal for controlling the opening/closing of the shutters of shutter glasses 50 when a 3D image is displayed on panel 10. Control signal generation circuit 45 sets the shutter opening/closing timing signal at ON (“1”) when the shutters of shutter glasses 50 are opened (visible light is transmitted), and sets the shutter opening/closing timing signal at OFF (“0”) when the shutters of shutter glasses 50 are closed (visible light is blocked).

The shutter opening/closing timing signal includes the following signals:
a right-eye timing signal (right-eye shutter opening/closing timing signal) that is set at ON when the right-eye field based on the right-eye image signal of the 3D image is displayed on panel 10, and is set at OFF when the left-eye field based on the left-eye image signal is displayed; and
a left-eye timing signal (left-eye shutter opening/closing timing signal) that is set at ON when the left-eye field based on the left-eye image signal of the 3D image is displayed, and is set at OFF when the right-eye field based on the right-eye image signal is displayed.

In the present exemplary embodiment, control signal generation circuit 45 generates a shutter opening/closing timing signal during the 3D drive so as to satisfy the following conditions:
both the right-eye shutter and left-eye shutter are close in the initializing period of the first subfield;
the average value of the transmittance of the right-eye shutter is lower than 100% in the sustain period of the first subfield in the right-eye field; and
the average value of the transmittance of the left-eye shutter is lower than 100% in the sustain period of the first subfield in the left-eye field. The details of this operation are described later.

In the present exemplary embodiment, the frequencies of the horizontal synchronizing signal and vertical synchronizing signal are not limited to the above-mentioned numerical values.

Timing signal output section 49 has a light emitting element such as a light emitting diode (LED). Timing signal output section 49 converts a shutter opening/closing timing signal into an infrared signal, for example, and supplies it to shutter glasses 50.

Data electrode driver circuit 42 converts the image data based on the 2D image signal or the data of each subfield based on the 3D image signal, which constitutes right-eye image data and left-eye image data, into a signal corresponding to each of data electrode D1 through data electrode Dm. Data electrode driver circuit 42 drives each of data electrode D1 through data electrode Dm based on the converted signal and the control signal supplied from timing generation circuit 45. Data electrode driver circuit 42 generates an address pulse and applies it to each of data electrode D1 through data electrode Dm in the address period.

Scan electrode driver circuit 43 has an initializing waveform generation circuit (not shown in FIG. 3), sustain pulse generation circuit 80, and a scan pulse generation circuit (not shown in FIG. 3). Scan electrode driver circuit 43 generates a driving voltage waveform based on the control signal supplied from control signal generation circuit 45, and applies it to each of scan electrode SC1 through scan electrode SCn. The initializing waveform generation circuit generates an initializing waveform to be applied to scan electrode SC1 through scan electrode SCn based on the control signal in the initializing period. Sustain pulse generation circuit 80 generates a sustain pulse to be applied to scan electrode SC1 through scan electrode SCn based on the control signal in the sustain period. The scan pulse generation circuit has a plurality of scan electrode driver ICs (scan ICs), and generates a scan pulse to be applied to scan electrode SC1 through scan electrode SCn based on the control signal in the address period.

Sustain electrode driver circuit 44 has sustain pulse generation circuit 60 and a circuit (not shown in FIG. 3) for generating voltage Ve1 and voltage Ve2. Sustain electrode driver circuit 44 generates a driving voltage waveform based on the control signal supplied from control signal generation circuit 45, and applies it to each of sustain electrode SU1 through sustain electrode SUn. Sustain electrode driver circuit 44 generates a sustain pulse based on the control signal and applies it to sustain electrode SU1 through sustain electrode SUn in the sustain period.

Shutter glasses 50 include right-eye shutter 52R, left-eye shutter 52L, and a signal receiving section (not shown) for receiving a signal (for example, an infrared signal) output from timing signal output section 49. Right-eye shutter 52R and left-eye shutter 52L can be independently opened or closed. Shutter glasses 50 open or close right-eye shutter 52R and left-eye shutter 52L based on the shutter opening/closing timing signal supplied from timing signal output section 49.

Right-eye shutter 52R is opened (visible light is transmitted) when the right-eye timing signal is in the ON state, and is closed (visible light is blocked) when it is in the OFF state. Left-eye shutter 52L is opened (visible light is transmitted) when the left-eye timing signal is in the ON state, and is closed (visible light is blocked) when it is in the OFF state.

Right-eye shutter 52R and left-eye shutter 52L can be made of liquid crystal, for example. However, the material of the shutters of the present invention is not limited to the liquid crystal, but may be any material as long as the material allows high speed switching between the blocking and transmission of visible light.

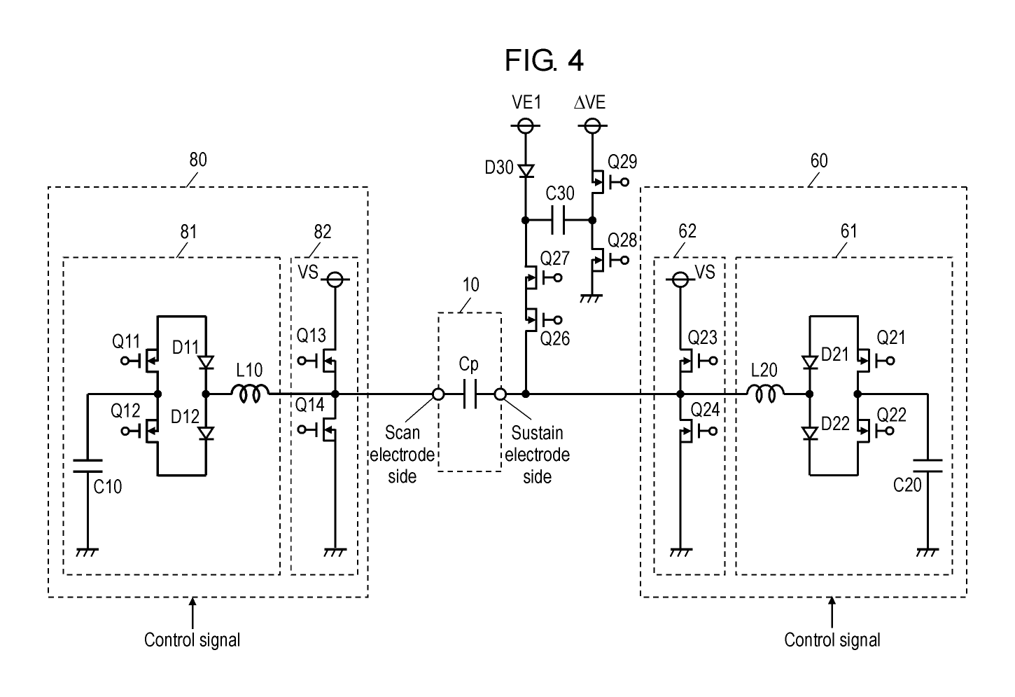

Next, the details and operations of sustain pulse generation circuit 80 and sustain pulse generation circuit 60 are described. FIG. 4 is a circuit diagram showing one configuration example of sustain pulse generation circuit 80 and sustain pulse generation circuit 60 in accordance with the first exemplary embodiment of the present invention. In FIG. 4, the inter-electrode capacity of panel 10 is denoted with Cp, and circuits for generating a scan pulse and initializing voltage waveform are omitted.

Sustain pulse generation circuit 80 includes power recovery circuit 81 and clamping circuit 82. Power recovery circuit 81 and clamping circuit 82 are connected to scan electrode SC1 through scan electrode SCn, which exist at one end of inter-electrode capacity Cp of panel 10, via the scan pulse generation circuit (not shown in FIG. 4 because the circuit is short-circuited in the sustain period).

Power recovery circuit 81 includes capacitor C10 for power recovery, switching element Q11, switching element Q12, diode D11 for back flow prevention, diode D12 for back flow prevention, and inductor L10 for resonance. Power recovery circuit 81 raises and drops a sustain pulse by LC-resonance between inter-electrode capacity Cp and inductor L10. Thus, power recovery circuit 81 drives scan electrode SC1 through scan electrode SCn by LC resonance without receiving electric power from a power supply. Therefore, the output impedance of power recovery circuit 81 is higher than that of clamping circuit 82, but the power consumption thereof is zero, ideally. Capacitor C10 for power recovery has a capacity sufficiently larger than inter-electrode capacity Cp and is charged to about Vs/2, namely a half of voltage value Vs, so that it works as a power supply of power recovery circuit 81.

Clamping circuit 82 has switching element Q13 for clamping scan electrode SC1 through scan electrode SCn on voltage Vs, and switching element Q14 for clamping scan electrode SC1 through scan electrode SCn on 0 (V) as base potential. Clamping circuit 82 connects scan electrode SC1 through scan electrode SCn to power supply VS via switching element Q13, thereby clamping them on voltage Vs. Clamping circuit 82 grounds scan electrode SC1 through scan electrode SCn to clamp them on 0 (V) via switching element Q14. Therefore, the impedance when voltage is applied from clamping circuit 82 to scan electrode SC1 through scan electrode SCn is low, and clamping circuit 82 can stably feed large discharge current occurring when strong sustain discharge is caused.

Sustain pulse generation circuit 80 generates a sustain pulse by operating power recovery circuit 81 and clamping circuit 82 by switching between turn on and turn off of each of switching element Q11, switching element Q12, switching element Q13, and switching element Q14 in response to the control signal output from control signal generation circuit 45. In FIG. 4, the details of the signal path of the control signal are omitted.

For example, when a sustain pulse is raised, switching element Q11 is set at ON to cause resonance between inter-electrode capacity Cp and inductor L10, and supplies electric power from capacitor C10 for power recovery to scan electrode SC1 through scan electrode SCn via switching element Q11, diode D11, and inductor L10. When the voltage of scan electrode SC1 through scan electrode SCn approaches voltage Vs, switching element Q13 is set at ON. Thus, a circuit for driving scan electrode SC1 through scan electrode SCn is switched from power recovery circuit 81 to clamping circuit 82, and scan electrode SC1 through scan electrode SCn are clamped on voltage Vs.

Conversely, when a sustain pulse is dropped, switching element Q12 is set at ON to cause resonance between inter-electrode capacity Cp and inductor L10, and recovers electric power from inter-electrode capacity Cp to capacitor C10 for power recovery via inductor L10, diode D12, and switching element Q12. When the voltage of scan electrode SC1 through scan electrode SCn approaches 0 (V), switching element Q14 is set at ON. Thus, a circuit for driving scan electrode SC1 through scan electrode SCn is switched from power recovery circuit 81 to clamping circuit 82, and scan electrode SC1 through scan electrode SCn are clamped on 0 (V) as base potential.

Thus, sustain pulse generation circuit 80 generates a sustain pulse. These switching elements can be formed using a generally known element such as a metal oxide semiconductor field effect transistor (MOSFET) or an insulated gate bipolar transistor (IGBT).

Sustain pulse generation circuit 60 has substantially the same configuration as that of sustain pulse generation circuit 80, and includes power recovery circuit 61 and clamping circuit 62. Power recovery circuit 61 includes capacitor C20 for power recovery, switching element Q21, switching element Q22, diode D21 for back flow prevention, diode D22 for back flow prevention, and inductor L20 for resonance. Power recovery circuit 61 recovers the electric power when sustain electrode SU1 through sustain electrode SUn are driven and reuses it. Clamping circuit 62 has switching element Q23 for clamping sustain electrode SU1 through sustain electrode SUn on voltage Vs, and switching element Q24 for clamping sustain electrode SU1 through sustain electrode SUn on ground potential (0 (V)). Sustain pulse generation circuit 60 is connected to sustain electrode SU1 through sustain electrode SUn, which exist at one end of inter-electrode capacity Cp of panel 10.

Sustain pulse generation circuit 60 generates a sustain pulse by operating power recovery circuit 61 and clamping circuit 62 by switching between turn on and turn off of each of switching element Q21, switching element Q22, switching element Q23, and switching element Q24 in response to the control signal output from control signal generation circuit 45. These operations of sustain pulse generation circuit 60 are similar to those of sustain pulse generation circuit 80, and hence are not described.

FIG. 4 shows power supply VE1 for generating voltage Ve1, switching element Q26 and switching element Q27 for applying voltage Ve1 to sustain electrodes SU1 through sustain electrode SUn, power supply AVE for generating voltage ΔVe, diode D30 for back flow prevention, capacitor C30 for a charge pump for adding voltage ΔVe to voltage Ve1, switching element Q28 and switching element Q29 for adding voltage ΔVe to voltage Ve1 to generate voltage Ve2.

For example, with a timing of applying voltage Ve1, switching element Q26 and switching element Q27 are turned on and positive voltage Ve1 is applied to sustain electrodes SU1 through sustain electrode SUn via diode D30, switching element Q26, and switching element Q27. At this time, switching element Q28 is turned on to charge capacitor C30 so that the voltage of capacitor C30 becomes voltage Ve1. With a timing of applying voltage Ve2, in the state where switching element Q26 and switching element Q27 are turned on, switching element Q28 is turned off and switching element Q29 is turned on to add voltage ΔVe to the voltage of capacitor C30. Thus, voltage Ve1+ΔVe, namely voltage Ve2, is applied to sustain electrodes SU1 through sustain electrode SUn. At this time, the current from capacitor C30 to power supply VE1 is interrupted by work of diode D30 for back flow prevention.

The circuit for applying voltage Ve1 and voltage Ve2 is not limited to the circuit shown in FIG. 4. For example, the circuit may have a configuration where each voltage is applied to sustain electrodes SU1 through sustain electrode SUn with a desired timing using a power supply for generating voltage Ve1, a power supply for generating voltage Ve2, and a plurality of switching elements for applying the respective voltages to sustain electrode SU1 through sustain electrode SUn.

The cycle of the LC resonance between inductor L10 and inter-electrode capacity Cp and the cycle (hereinafter referred to as “resonance cycle”) of the LC resonance between inductor L20 and inter-electrode capacity Cp can be determined using calculation equation 2π√(LCp) when the inductance of each of inductor L10 and inductor L20 is denoted as L. In the present exemplary embodiment, inductor L10 and inductor L20 are set so that the resonance cycles in power recovery circuit 81 and power recovery circuit 61 are 1600 nsec. However, this numerical value is simply one example of the exemplary embodiment, and the value of each inductance is set at optimal values in response to the characteristics of panel 10 and the specification of plasma display apparatus 1.

Next, a driving voltage waveform and its operation for driving panel 10 are described schematically.

Plasma display apparatus 1 of the present exemplary embodiment drives panel 10 by a subfield method. In this subfield method, the plasma display apparatus divides one field into a plurality of subfields on the time axis, and sets luminance weight for each subfield. Therefore, each field has a plurality of subfields. Each subfield has an initializing period, an address period, and a sustain period.

In the initializing period, an initializing operation of causing the initializing discharge in a discharge cell and producing wall charge required for address discharge in the subsequent address period on each electrode is performed.

In the address period, the address operation is performed where a scan pulse is applied to scan electrodes 22, an address pulse is selectively applied to data electrodes 32, address discharge is selectively caused in a discharge cell to emit light, and wall charge for generating sustain discharge in the subsequent sustain period is produced in the discharge cell.

In the sustain period, the following sustain operation is performed:
as many sustain pulses as the number derived by multiplying the luminance weight set for each subfield by a predetermined proportionality constant are alternately applied to scan electrode 22 and sustain electrode 23;
sustain discharge is caused in the discharge cell having undergone address discharge in the immediately preceding address period; and
light is emitted in the discharge cell.
   This proportionality constant is luminance magnification.

The luminance weight means the ratio between the luminances displayed in respective subfields, and as many sustain pulses as the number corresponding to the luminance weight are generated in each subfield in the sustain period. Therefore, in the subfield of luminance weight “8”, light is emitted at a luminance about eight times that in the subfield of luminance weight “1”, and light is emitted at a luminance about four times that in the subfield of luminance weight “2”.

For example, when the luminance magnification is two, four sustain pulses are applied to each of scan electrode 22 and sustain electrode 23 in the sustain period of the subfield of luminance weight “2”. Therefore, the number of sustain pulses occurring in the sustain period is 8.

Therefore, various gradations can be displayed and an image can be displayed on panel 10, by selectively emitting light in each subfield by controlling the light emission or no light emission in each discharge cell in each subfield using a combination corresponding to the image signal.

The initializing operation includes the following operations:
an all-cell initializing operation of causing initializing discharge in a discharge cell regardless of the operation in the immediately preceding subfield; and
a selective initializing operation of selectively causing initializing discharge only in a discharge cell having undergone address discharge in the address period and having undergone sustain discharge in the sustain period in the immediately preceding subfield.
   In the all-cell initializing operation, an increasing up-ramp waveform voltage and a decreasing down-ramp waveform voltage are applied to scan electrodes 22, and initializing discharge is caused in all discharge cells in the image display region. The all-cell initializing operation is performed in the initializing period of one subfield, of a plurality of subfields, and the selective initializing operation is performed in the initializing periods of the other subfields. The initializing period for performing the all-cell initializing operation is referred to as “all-cell initializing period”, and the subfield having the all-cell initializing period is referred to as “all-cell initializing subfield”. The initializing period for performing the selective initializing operation is referred to as “selective initializing period”, and the subfield having the selective initializing period is referred to as “selective initializing subfield”.

In the present exemplary embodiment, the all-cell initializing subfield is only the first subfield of each field (the subfield firstly occurring in the field). In other words, the all-cell initializing operation is performed in the initializing period of the first sub field (subfield SF1), and the selective initializing operation is performed in the initializing periods of the other subfields.

Thus, the initializing discharge can be caused in all discharge cells at least once per field, and the address operations after the all-cell initializing operation can be stabilized. The light emission related to no image display is only light emission following the discharge of the all-cell initializing operation in subfield SF1. The luminance of black level, which is luminance in a black displaying region that does not cause sustain discharge, is therefore determined only by weak light emission in the all-cell initializing operation. An image of sharp contrast can be displayed on panel 10.

In the present exemplary embodiment, however, the number of subfields constituting one field and the luminance weight of each subfield are not limited to the above-mentioned numerical values. The subfield structure may be changed based on an image signal or the like.

In the present exemplary embodiment, an image signal to be input to plasma display apparatus 1 is a 2D image signal or 3D image signal, and plasma display apparatus 1 drives panel 10 in response to each image signal. First, a driving voltage waveform applied to each electrode of panel 10 when a 2D image signal is input to plasma display apparatus 1 is described. Next, a driving voltage waveform applied to each electrode of panel 10 when a 3D image signal is input to plasma display apparatus 1 is described.

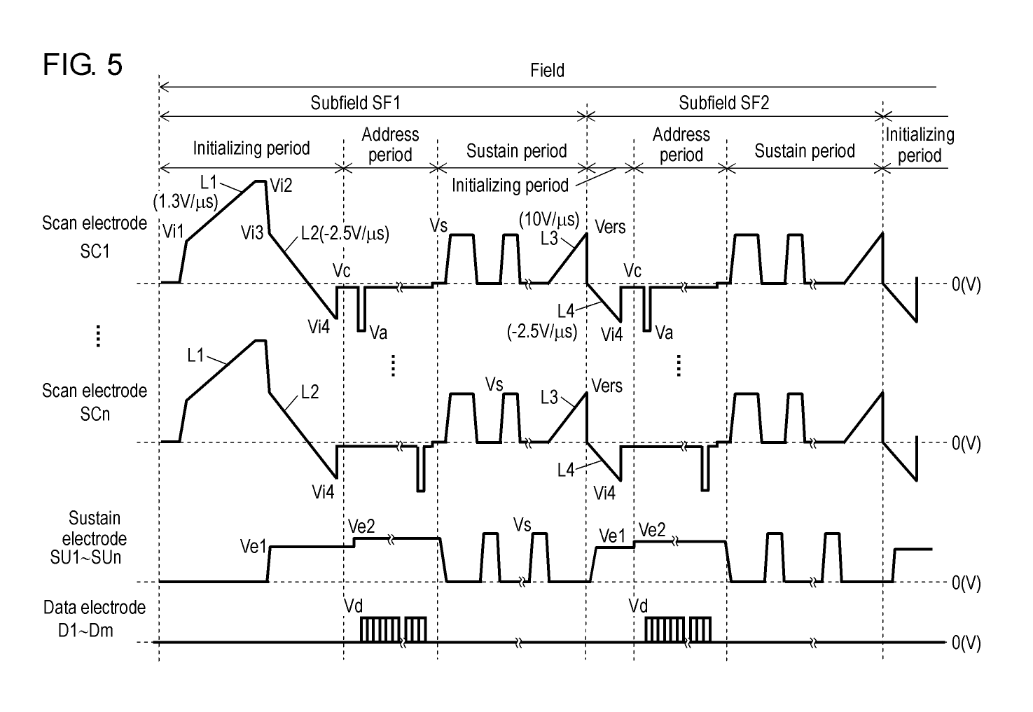

FIG. 5 is a diagram for schematically showing a driving voltage waveform to be applied to each electrode of panel 10 used in plasma display apparatus 1 in accordance with the first exemplary embodiment of the present invention. FIG. 5 shows driving voltage waveforms applied to scan electrode SC1 for firstly performing an address operation in the address period, scan electrode SCn (e.g. scan electrode SC1080) for finally performing the address operation in the address period, sustain electrode SU1 through sustain electrode SUn, and data electrode D1 through data electrode Dm. Each of scan electrode SCi, sustain electrode SUi, and data electrode Dk discussed later means an electrode that is selected from each kind of electrodes based on image data (which indicates light emission or no light emission in each subfield).

FIG. 5 shows driving voltage waveforms of two subfields, namely subfield SF1 and subfield SF2. The all-cell initializing operation is performed in subfield SF1, and the selective initializing operation is performed in subfield SF2. Therefore, the waveform of the driving voltage to be applied to scan electrode 22 in the initializing period differs between subfield SF1 and subfield SF2. The driving voltage waveforms in the other subfields are substantially the same as the driving voltage waveform in subfield SF2 except for the number of sustain pulses to be generated in the sustain period.

In the present exemplary embodiment, when plasma display apparatus 1 drives panel 10 in response to a 2D image signal, one field is formed of 8 subfields (subfield SF1, subfield SF2, . . . , subfield SF8), and subfield SF1 through subfield SF8 have luminance weights of (1, 2, 4, 8, 16, 32, 64, 128), respectively.

Thus, when panel 10 is driven in response to a 2D image signal in the present exemplary embodiment, the luminance weights of respective subfields are set in the following manner: the luminance weight of subfield SF1, which is the first subfield in the field, is the smallest, the luminance weights of the subsequent subfields increase sequentially, and the luminance weight of subfield SF8, which is the final subfield in the field, is the largest.

In the present exemplary embodiment, the number of subfields constituting one field and the luminance weight of each subfield are not limited to the above-mentioned values.

First, subfield SF1, which is an all-cell initializing subfield, is described.

In the first half of the initializing period of subfield SF1 for performing an all-cell initializing operation, voltage 0 (V) is applied to data electrode D1 through data electrode Dm and sustain electrode SU1 through sustain electrode SUn. To scan electrode SC1 through scan electrode SCn, voltage 0 (V) is applied, Vi1 is applied, and then an up-ramp waveform voltage, which gently (at a gradient of 1.3 V/μsec, for example) increases from voltage Vi1 to voltage Vi2, is applied. Hereinafter, the up-ramp waveform voltage is referred to as “ramp voltage L1”. Voltage Vi1 is set at a voltage lower than the discharge start voltage with respect to sustain electrode SU1 through sustain electrode SUn. Voltage Vi2 is set at a voltage exceeding the discharge start voltage.

While ramp voltage L1 increases, feeble initializing discharge continuously occurs between scan electrode SC1 through scan electrode SCn and sustain electrode SU1 through sustain electrode SUn in each discharge cell, and feeble initializing discharge continuously occurs between scan electrode SC1 through scan electrode SCn and data electrode D1 through data electrode Dm in each discharge cell. Then, negative wall voltage is accumulated on scan electrode SC1 through scan electrode SCn, and positive wall voltage is accumulated on data electrode D1 through data electrode Dm and sustain electrode SU1 through sustain electrode SUn. The wall voltage on the electrode means voltage generated by the wall charge accumulated on the dielectric layer for covering the electrodes, the protective layer, or the phosphor layers.

In the latter half of the initializing period of subfield SF1, positive voltage Ve1 is applied to sustain electrode SU1 through sustain electrode SUn, and voltage 0 (V) is applied to data electrode D1 through data electrode Dm. Down-ramp waveform voltage, which gently (at a gradient of −2.5 V/μsec, for example) decreases from voltage V13 to negative voltage V14, is applied to scan electrode SC1 through scan electrode SCn. Hereinafter, the down-ramp waveform voltage is referred to as “ramp voltage L2”. Voltage V13 is set at a voltage lower than the discharge start voltage with respect to sustain electrode SU1 through sustain electrode SUn, and voltage V14 is set at a voltage exceeding the discharge start voltage.

While ramp voltage L2 is applied to scan electrode SC1 through scan electrode SCn, feeble initializing discharge occurs between scan electrode SC1 through scan electrode SCn and sustain electrode SU1 through sustain electrode SUn in each discharge cell, and feeble initializing discharge occurs between scan electrode SC1 through scan electrode SCn and data electrode D1 through data electrode Dm in each discharge cell. Then, the negative wall voltage accumulated on scan electrode SC1 through scan electrode SCn and the positive wall voltage accumulated on sustain electrode SU1 through sustain electrode SUn are reduced, and the positive wall voltage accumulated on data electrode D1 through data electrode Dm is adjusted to a value suitable for an address operation.

Thus, the initializing operation in the initializing period of subfield SF1, namely the all-cell initializing operation of forcibly causing initializing discharge in all discharge cells, is completed, and the wall charge required for the subsequent address operation is formed on each electrode in all discharge cells.

In the subsequent address period in subfield SF1, voltage Ve2 is applied to sustain electrode SU1 through sustain electrode SUn, and voltage Vc (Va+Vscn, for example) is applied to scan electrode SC1 through scan electrode SCn.

Next, a scan pulse of negative polarity of negative voltage Va is applied to scan electrode SC1 in the first row for firstly performing an address operation. Then, an address pulse of positive polarity of positive voltage Vd is applied to data electrode Dk in the discharge cell to emit light in the first row, of data electrode D1 through data electrode Dm.

The voltage difference in the intersecting part of data electrode Dk and scan electrode SC1 in the discharge cell to which the address pulse of voltage Vd has been applied is derived by adding the difference between the wall voltage on data electrode Dk and that on scan electrode SC1 to the difference (voltage Vd−voltage Va) of the external applied voltage. Thus, the voltage difference between data electrode Dk and scan electrode SC1 exceeds the discharge start voltage, and discharge occurs between data electrode Dk and scan electrode SC1.

Since voltage Ve2 is applied to sustain electrode SU1 through sustain electrode SUn, the voltage difference between sustain electrode SU1 and scan electrode SC1 is derived by adding the difference between the wall voltage on sustain electrode SU1 and that on scan electrode SC1 to the difference (voltage Ve2−voltage Va) of the external applied voltage. At this time, by setting voltage Ve2 at a voltage value slightly lower than the discharge start voltage, a state where discharge does not occur but is apt to occur can be caused between sustain electrode SU1 and scan electrode SC1.

Therefore, the discharge occurring between data electrode Dk and scan electrode SC1 can cause discharge between sustain electrode SU1 and scan electrode SC1 that exist in a region crossing data electrode Dk. Thus, address discharge occurs in the discharge cell (to emit light) to which a scan pulse and address pulse are simultaneously applied, positive wall voltage is accumulated on scan electrode SC1, negative wall voltage is accumulated on sustain electrode SU1, and negative wall voltage is also accumulated on data electrode Dk.

Thus, the address operation in the discharge cell in the first row is completed. The voltage in the part where scan electrode SC1 intersects with data electrode 32 to which no address pulse has been applied does not exceed the discharge start voltage, so that address discharge does not occur.

Next, a scan pulse is applied to scan electrode SC2 in the second row, an address pulse is applied to data electrode Dk corresponding to the discharge cell to emit light in the second row, and the address operation is performed in the discharge cell of the second row.

This address operation is sequentially performed until it reaches the discharge cell in the n-th row in the order of scan electrode SC3, scan electrode SC4, . . . , and scan electrode SCn, and the address period in subfield SF1 is completed. Thus, in the address period, address discharge is selectively caused in the discharge cell to emit light, and wall charge is formed in the discharge cell.

In the subsequent sustain period in subfield SF1, voltage 0 (V) as base potential is firstly applied to sustain electrode SU1 through sustain electrode SUn, and a sustain pulse of positive voltage Vs is applied to scan electrode SC1 through scan electrode SCn.

In the discharge cell having undergone address discharge, by application of the sustain pulse, the voltage difference between scan electrode SCi and sustain electrode SUi is obtained by adding the difference between the wall voltage on scan electrode SCi and that on sustain electrode SUi to voltage Vs of the sustain pulse.

Thus, the voltage difference between scan electrode SCi and sustain electrode SUi exceeds the discharge start voltage, and sustain discharge occurs between scan electrode SCi and sustain electrode SUi. Ultraviolet rays generated by this discharge cause phosphor layer 35 to emit light. By this discharge, negative wall voltage is accumulated on scan electrode SCi, and positive wall voltage is accumulated on sustain electrode SUi. Positive wall voltage is also accumulated on data electrode Dk. In the discharge cell having undergone no address discharge in the address period, sustain discharge does not occur.

Subsequently, voltage 0 (V) is applied to scan electrode SC1 through scan electrode SCn, and a sustain pulse of voltage Vs is applied to sustain electrode SU1 through sustain electrode SUn. In the discharge cell having undergone the sustain discharge immediately before it, the voltage difference between sustain electrode SUi and scan electrode SCi exceeds the discharge start voltage. Thus, in the discharge cell having undergone the sustain discharge immediately before it, sustain discharge occurs between sustain electrode SUi and scan electrode SCi again, negative wall voltage is accumulated on sustain electrode SUi, and positive wall voltage is accumulated on scan electrode SCi.

Hereinafter, similarly, as many sustain pulses as the number derived by multiplying the luminance weight by a predetermined luminance magnification are alternately applied to scan electrode SC1 through scan electrode SCn and sustain electrode SU1 through sustain electrode SUn. Thus, by applying the potential difference between the electrodes of display electrode pair 24, sustain discharge is continuously performed in the discharge cell having undergone the address discharge in the address period, and light is emitted at a luminance corresponding to the luminance weight in the discharge cell having undergone the address discharge in the address period.

After generation of a sustain pulse in the sustain period (at the end of the sustain period), in the state where voltage 0 (V) is applied to sustain electrode SU1 through sustain electrode SUn and data electrode D1 through data electrode Dm, ramp waveform voltage, which gently (at a gradient of about 10 V/μsec, for example) increases from voltage 0 (V) as base potential to voltage Vers, is applied to scan electrode SC1 through scan electrode SCn. Hereinafter, the ramp waveform voltage is referred to as “erasing ramp voltage L3”.

While erasing ramp voltage L3 applied to scan electrode SC1 through scan electrode SCn increases beyond the discharge start voltage, feeble discharge continuously occurs in the discharge cell having undergone sustain discharge. Charged particles generated by the feeble discharge are accumulated as wall charge on sustain electrode SUi and scan electrode SCi so as to reduce the voltage difference between sustain electrode SUi and scan electrode SCi. Therefore, the wall voltages on scan electrode SCi and sustain electrode SUi are reduced while the positive wall voltage is left on data electrode Dk. In other words, unnecessary wall charge in the discharge cell is erased.

When the voltage applied to scan electrode SC1 through scan electrode SCn arrives at voltage Vers, the apply voltage to scan electrode SC1 through scan electrode SCn is decreased to voltage 0 (V). Thus, the sustain operation in the sustain period in subfield SF1 is completed.

Thus, subfield SF1 is completed.

In the initializing period of subfield SF2 for performing the selective initializing operation, the selective initializing operation of applying, to each electrode, the driving voltage waveform where the first half of the initializing period of subfield SF1 is omitted is performed.

In the initializing period of subfield SF2, voltage Ve1 is applied to sustain electrode SU1 through sustain electrode SUn, and voltage 0 (V) is applied to data electrode D1 through data electrode Dm. Ramp waveform voltage, which decreases from voltage (e.g. voltage 0 (V)) lower than the discharge start voltage to negative voltage V14 at the same gradient (e.g. about −2.5 V/μsec) as that of ramp voltage L2, is applied to scan electrode SC1 through scan electrode SCn. Hereinafter, the ramp waveform voltage is referred to as “ramp voltage L4”. Voltage V14 is set to exceed the discharge start voltage with respect to sustain electrode SU1 through sustain electrode SUn.

While ramp voltage L4 is applied to scan electrode SC1 through scan electrode SCn, feeble initializing discharge occurs in the discharge cell having undergone the sustain discharge in the sustain period of the immediately preceding subfield (subfield SF1 in FIG. 5). Then, the wall voltages on scan electrode SCi and sustain electrode SUi are reduced by the initializing discharge. Since sufficient positive wall voltage is accumulated on data electrode Dk by sustain discharge occurring in the sustain period of the immediately preceding subfield, the excessive part of this wall voltage is discharged, and the wall voltage on data electrode Dk is adjusted to the wall voltage suitable for the address operation.

In the discharge cell having undergone no sustain discharge in the sustain period of the immediately preceding subfield (subfield SF1), initializing discharge does not occur, and the wall voltage is kept as it is.

The initializing operation in subfield SF2 thus becomes the selective initializing operation of selectively causing initializing discharge in the discharge cell that has undergone address operation in the address period of the immediately preceding subfield, namely in the discharge cell that has undergone sustain discharge in the sustain period of the immediately preceding subfield.

Thus, the initializing operation in the initializing period in subfield SF2, namely the selective initializing operation, is completed.

In the address period of subfield SF2, the address operation is performed where a driving voltage waveform similar to that in the address period of subfield SF1 is applied to each electrode, and wall voltage is accumulated on each electrode of the discharge cell to emit light.

In the subsequent sustain period, similarly to the sustain period of subfield SF1, as many sustain pulses as the number corresponding to the luminance weight are alternately applied to scan electrode SC1 through scan electrode SCn and sustain electrode SU1 through sustain electrode SUn, and sustain discharge is caused in the discharge cell that has undergone address discharge in the address period.

In the initializing period and address period of each of subfield SF3 and later, a driving voltage waveform similar to that in the initializing period and address period of subfield SF2 is applied to each electrode. In the sustain period of each of subfield SF3 and later, a driving voltage waveform similar to that in subfield SF2 is applied to each electrode except for the number of sustain pulses generated in the sustain period.

The driving voltage waveform applied to each electrode of panel 10 of the present exemplary embodiment has been described schematically.

In the present exemplary embodiment, the following voltage values are applied to respective electrodes, for example. Voltage Vi1 is 145 (V), voltage Vi2 is 335 (V), voltage Vi3 is 190 (V), voltage Vi4 is −160 (V), voltage Va is −180 (V), voltage Vs is 190 (V), voltage Vers is 190 (V), voltage Ve1 is 125 (V), voltage Ve2 is 130 (V), and voltage Vd is 60 (V). Voltage Vc can be generated by adding positive voltage Vscn=145 (V) to negative voltage Va=−180 (V) (Vc=Va+Vscn), and in this case voltage Vc is −35 (V).

The specific numerical values of the voltage values and gradients of the ramp waveform voltage are simply one example, and the voltage values and gradients of the present invention are not limited to the above-mentioned numerical values. Preferably, the voltage values and gradients are set optimally based on the discharge characteristics of the panel and the specification of the plasma display apparatus.

Next, a driving voltage waveform that is applied to each electrode of panel 10 when a 3D image signal is input to plasma display apparatus 1 is described using an opening/closing operation of the shutters of shutter glasses 50.

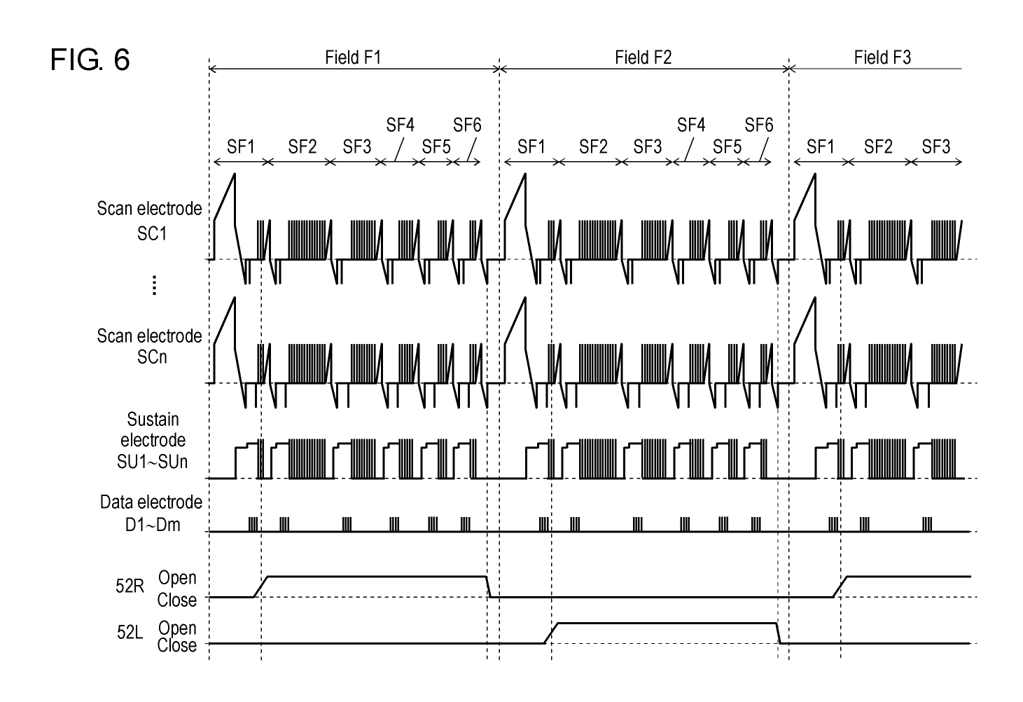

FIG. 6 is a waveform chart for schematically showing a driving voltage waveform applied to each electrode of panel 10 used in plasma display apparatus 1 and an opening/closing operation of shutter glasses 50 in accordance with the first exemplary embodiment of the present invention.

FIG. 6 shows driving voltage waveforms applied to scan electrode SC1 for firstly performing an address operation in the address period, scan electrode SCn (e.g. scan electrode SC1080) for finally performing the address operation in the address period, sustain electrode SU1 through sustain electrode SUn, and data electrode D1 through data electrode Dm. FIG. 6 shows the opening/closing operations of right-eye shutter 52R and left-eye shutter 52L.

The 3D image signal is an image signal for 3D vision for alternately repeating a right-eye image signal and a left-eye image signal in each field. When the 3D image signal is input, as shown in FIG. 6, plasma display apparatus 1 alternately displays a right-eye image and a left-eye image on panel 10 by alternately repeating a right-eye field for displaying the right-eye image signal and a left-eye field for displaying the left-eye image signal.

For example, of three fields (field F1 through field F3) of FIG. 6, field F1 and field F3 are right-eye fields, and display a right-eye image signal on panel 10. Field F2 is a left-eye field, and displays a left-eye image signal on panel 10. Plasma display apparatus 1 displays a 3D image for 3D vision formed of the right-eye image and the left-eye image on panel 10.

One 3D image is formed of one right-eye image and one left-eye image. Therefore, a user who views a 3D image displayed on panel 10 through shutter glasses 50 recognizes images (right-eye image and left-eye image) displayed in two fields as one 3D image. Therefore, when the 3D image is displayed, a half the image displayed on the panel per unit time (for example, one second) is the right-eye image, and the remaining half is the left-eye image. Therefore, the user observes the number of 3D images displayed on panel 10 per unit time (for example, one second), as a half the field frequency (the number of fields generated per second).

For example, when the field frequency (the number of fields generated per second) of the 3D image displayed on the panel is 60 Hz, the number of right-eye images displayed on panel 10 per second is 30 and the number of left-eye images displayed on it per second is 30. The user therefore observes 30 3D images per second.

When the number of images displayed on the panel per unit time is reduced, fluctuation in image called flicker is apt to occur.

When a 2D image signal of a field frequency of 60 Hz is input, 60 images are displayed on panel 10 per second. In this case, the flicker is almost insignificant. Therefore, in order to display 60 3D images on panel 10 per second similarly to the 2D image, the field frequency of the 3D image signal must be set at 120 Hz, namely two times 60 Hz. In the present exemplary embodiment, in order that the user can smoothly observe a 3D moving image, the field frequency is set to be twice (for example, 120 Hz) the normal frequency, and fluctuation (flicker) in image apt to occur when an image of low field frequency is displayed is reduced.

The user views a 3D image displayed on panel 10 through shutter glasses 50 that independently opens or closes right-eye shutter 52R and left-eye shutter 52L synchronously with the right-eye field and the left-eye field. Thus, the user can observe the right-eye image only with the right eye and observe the left-eye image only with the left eye, so that the 3D image displayed on panel 10 can be viewed three-dimensionally.

The right-eye field and the left-eye field are different from each other only in the image signal to be displayed. The fields have the same structure, for example, the number of subfields constituting one field, luminance weight of each subfield, and arrangement of the subfields. When no differentiation between “right-eye” and “left-eye” is required, the right-eye field and the left-eye field are simply referred to as “fields”, the right-eye image signal and the left-eye image signal are simply referred to as “image signals”. The structure of the field may be also referred to as “subfield structure”.

In plasma display apparatus 1 of the present exemplary embodiment, in order to reduce the flicker (display image fluctuates) when panel 10 is driven in response to a 3D image signal, the field frequency is set at a frequency (e.g. 120 Hz) that is twice the frequency when a 2D image signal is displayed on panel 10, as discussed above. Therefore, the one-field period (e.g. 8.3 msec) when a 3D image signal is displayed on panel 10 is a half the one-field period (e.g. 16.7 msec) when a 2D image signal is displayed on panel 10.

In plasma display apparatus 1 of the present exemplary embodiment, the number of subfields constituting one field is made smaller when panel 10 is driven in response to a 3D image signal than when panel 10 is driven in response to a 2D image signal. In the present exemplary embodiment, an example is described where each of a right-eye field and a left-eye field has six subfields (subfield SF1, subfield SF2, subfield SF3, subfield SF4, subfield SF5, subfield SF6). Each subfield has an initializing period, an address period, and a sustain period similarly to the case where panel 10 is driven in response to the 2D image signal. An all-cell initializing operation is performed in the initializing period of subfield SF1, and a selective initializing operation is performed in the initializing periods of the other subfields.

Subfield SF1 through subfield SF6 have luminance weights of (1, 17, 8, 4, 2, 1). Thus, in the present exemplary embodiment, the luminance weights of respective subfields are set so that the luminance weight of subfield SF1, which is the first subfield in the field, is the smallest, the luminance weight of subfield SF2, which is the second subfield, is the largest, and the luminance weights of the subsequent subfields decrease sequentially.

In the present exemplary embodiment, by making each field have such a subfield structure, leak of emitted light from the right-eye image to the left-eye image and leak (crosstalk) of emitted light from the left-eye image to the right-eye image are reduced, and the address operation is stabilized. The details of this phenomenon are described later.

The driving voltage waveform applied to each electrode in each subfield is similar to that when a 2D image signal is displayed on panel 10 except for the number of sustain pulses generated in the sustain period, and hence is not described.

In the present exemplary embodiment, when a 3D image signal is displayed on panel 10, the luminance weights of the subfields constituting one field sequentially decrease as subfields are sequentially generated, namely the luminance weights of the sequentially generated subfields are decreased, except for subfield SF1. The reason is described below.

Phosphor layer 35 used in panel 10 has afterglow characteristics depending on the material forming the phosphor. The afterglow means the phenomenon where the phosphor continues the light emission even after the completion of discharge. The intensity of the afterglow is proportional to the luminance during the light emission of the phosphors. As the luminance during light emission of the phosphor becomes high, the afterglow becomes strong. There is also a phosphor material having the following characteristics: the afterglow attenuates at a time constant corresponding to the characteristics of the phosphor and the luminance gradually decreases with the passage of time, but the afterglow continues for several milliseconds even after the completion of sustain discharge. As the luminance during light emission of the phosphor becomes high, the time required for sufficient attenuation of the afterglow becomes long.

The light emission occurring in a subfield of a large luminance weight has a luminance higher than that of the light emission occurring in a subfield of a small luminance weight. Therefore, the luminance of the afterglow by the light emission occurring in a subfield of a large luminance weight is higher than that of the afterglow by the light emission occurring in a subfield of a small luminance weight, and the time required for the attenuation is also longer.

Therefore, when the final subfield of one field is set as the subfield of a large luminance weight, the afterglow leaking to the subsequent field is larger than that when the final subfield is set as the subfield of a small luminance weight.

In plasma display apparatus 1 for displaying a 3D image on panel 10 by alternately generating a right-eye field and a left-eye field, when the afterglow occurring in one field leaks into the subsequent field, a user observes the afterglow as unnecessary light emission related to no image signal. This phenomenon is “crosstalk”.

Therefore, as the afterglow leaking from one field to the next field increases, the crosstalk degrades, 3D vision of the 3D image is disturbed, and the image display quality in plasma display apparatus 1 reduces. This image display quality means the image display quality for a user who views the 3D image through shutter glasses 50.

In order to reduce the afterglow leaking from one field to the next field and reduce the crosstalk, preferably, a subfield of a large luminance weight is generated in an early time of the one field, strong afterglow is converged in the one field as much as possible, and the final subfield of the one field is made to have a small luminance weight to minimize the afterglow leaking to the next field.

In other words, in order to suppress the crosstalk when a 3D image signal is displayed on panel 10, the subfield having a relatively large luminance weight is generated at the beginning of the field, the luminance weights of the subsequent subfields are sequentially decreased, and the subfield having a relatively small luminance weight is generated at the end of the field. Thus, preferably, the leak of the afterglow to the next field is minimized.

This is the reason why the luminance weights of the subfields other than subfield SF1, of a plurality of subfields constituting one field, are set so that those of the subfields generated sequentially are decreased. In the present exemplary embodiment, the number of subfields constituting one field and luminance weights of the subfields are not limited to the above-mentioned numerical values. For example, the structure may be employed where subfield SF1 has the smallest luminance weight, subfield SF2 has the largest luminance weight, subfield SF3 and later have luminance weights that are sequentially decreased, and the final subfield of the field has the second smallest luminance weight.

In the present exemplary embodiment, in order to reduce the luminance of black level and stabilize the address discharge, subfield SF1 is set as the all-cell initializing subfield and the other subfields are set as the selective initializing subfields. Therefore, in the initializing period of subfield SF1, initializing discharge can be caused to generate wall charge and priming particles required for the address operation in all discharge cells.

However, the wall charge and priming particles generated by the all-cell initializing operation in the initializing period of subfield SF1 gradually disappear with the passage of time. When the wall charge and priming particles become insufficient, the address operation becomes unstable.

The wall charge and priming particles gradually can disappear with the passage of time and the address operation in the final subfield can become unstable in the following discharge cell: after the initializing discharge occurs in the all-cell initializing operation of subfield SF1, no address operation is performed in a midway subfield and an address operation is performed only in the final subfield, for example.

However, the wall charge and priming particles are supplied by the generation of sustain discharge. For example, in the discharge cell where sustain discharge occurs in the sustain period of subfield SF1, the wall charge and priming particles are supplied by the sustain discharge.

In a generally viewed moving image, it is recognized that the occurrence frequency of sustain discharge is higher in a subfield of a relatively small luminance weight than in a subfield of a relatively large luminance weight.

Therefore, during 2D drive whose one-field period is longer than that during 3D drive, a subfield of high sustain discharge occurrence frequency and small luminance weight is generated at the beginning of one field, the luminance weights are increased as subfields are sequentially generated in the one field. Thus, during 2D drive, the occurrence probability of sustain discharge at the beginning of the one field can be increased, the number of discharge cells where wall charge and priming particles are supplied by the sustain discharge at the beginning of the one field can be increased, and the address operation in the final subfield of the one field can be stabilized.

During 3D drive, in order to reduce the crosstalk, it is preferably set that the luminance weights of the respective subfields are decreased as subfields are sequentially generated in one field, as discussed above. When the subfield having the largest luminance weight is set as the first subfield, however, the number of discharge cells into which the wall charge and priming particles are supplied by the sustain discharge in the first subfield of a field reduces. In addition, the sustain period of a subfield having a large luminance weight is long. Therefore, when a subfield having a large luminance weight is generated at the beginning of the field, the period after the all-cell initializing operation until the address operation becomes long in the subsequent subfields. The address operation can therefore become unstable in the subsequent subfields.

In order to reconcile the reduction in crosstalk with the stabilization of the address operation in the final subfield of one field, preferably, the following subfield structure is employed:
the luminance weights of the subfields are set to decrease as subfields are sequentially generated in the one field, and a subfield having a large luminance weight is generated at an early time in the one field; and
sustain discharge is caused at the beginning of the field to allow the wall charge and priming particles to be supplied.

In the present exemplary embodiment, therefore, subfield SF1 is set to have the smallest luminance weight. The probability of occurrence of sustain discharge in the sustain period of subfield SF1 can be therefore increased. Subfield SF2 is set to have the largest luminance weight, and subfield SF3 and later are set to have luminance weights that are sequentially decreased.

Thus, leak of afterglow to the next field can be reduced to reduce the crosstalk, the number of discharge cells into which the wall charge and priming particles are supplied by the sustain discharge caused in the sustain period of subfield SF1 can be increased, and the address operation in the subsequent subfields can be stabilized.

Next, the control of a shutter opening/closing operation of shutter glasses 50 is described.

“Transmittance” of each shutter used in the following description means how much the shutter of shutter glasses 50 open. The rate of transmitting visible light is represented by percentage, assuming that the completely open state of the shutter has a transmittance of 100% (maximum transmittance) and the completely close state of the shutter has a transmittance of 0% (minimum transmittance).

The opening/closing operation of right-eye shutter 52R and left-eye shutter 52L of shutter glasses 50 is controlled based on ON or OFF of a shutter opening/closing timing signal (right-eye shutter opening/closing timing signal and left-eye shutter opening/closing timing signal) that is output from timing signal output section 49 and is received by shutter glasses 50.

Control signal generation circuit 45, when the driver circuit of plasma display apparatus 1 performs 3D drive, generates a shutter opening/closing timing signal so that both the right-eye shutter opening/closing timing signal and left-eye shutter opening/closing timing signal are OFF in the initializing period (all-cell initializing period) of subfield SF1 in both the right-eye field and the left-eye field.

In the present exemplary embodiment, the all-cell initializing operation of subfield SF1 causes the initializing discharge to emit light in all discharge cells. This light emission increases the luminance of black level, though slightly. In the present exemplary embodiment, therefore, shutter glasses 50 are controlled so that, when a 3D image is displayed on panel 10, both right-eye shutter 52R and left-eye shutter 52L are closed in the initializing period (all-cell initializing period) of subfield SF1 in both the right-eye field and the left-eye field.

Emitted light by the all-cell initializing operation is blocked by right-eye shutter 52R and left-eye shutter 52L, and hence does not enter the eyes of the user. Therefore, a user (hereinafter referred to as “user” simply) who views a 3D image through shutter glasses 50 cannot see the emitted light by the all-cell initializing operation and observes black whose luminance is reduced by a value corresponding to the emitted light, so that the user can observe an image of sharp contrast.

When both right-eye shutter 52R and left-eye shutter 52L are closed, the afterglow is also blocked. Therefore, by delaying the timing of opening the shutters as much as possible, the period for blocking the afterglow can be extended and the effect of reducing the crosstalk can be enhanced.

In shutter glasses 50, the period after a shutter starts to be closed until the shutter is completely closed or the period after a shutter starts to be opened until the shutter is completely opened depends on the characteristics of the material (e.g. liquid crystal) of the shutters. For example, in the case of shutter glasses 50 where the shutters are made of liquid crystal, the period after a shutter starts to be closed until the shutter is completely closed is about 0.5 msec, and the period after a shutter starts to be opened until the shutter is completely opened can be about 2 msec.

Therefore, in order to set the transmittance of a shutter at 100% in the sustain period of subfield SF1, the opening of the shutter must be started early in consideration of the characteristics of the shutter. When the timing of starting the opening of the shutter is late, the average value of the transmittance of the shutter can not arrive at 100% in the sustain period of subfield SF1.

Regarding a discharge cell that uses a phosphor (long-afterglow phosphor) having afterglow characteristics of a large time constant, the inventor has confirmed the following phenomenon:
a user does not substantially sense the reduction in luminance in a subfield of a small luminance weight even when the average value of the transmittance of the shutter in the sustain period is not 100%, namely even when the shutter is not completely open at the beginning of the sustain period.

For example, regarding a discharge cell using a long-afterglow phosphor where the time constant of the afterglow is about 3 msec, the following phenomenon has been confirmed: the user does not substantially sense the reduction in luminance in a subfield of luminance weight “1” even when the average value of the transmittance of the shutter in the sustain period is about 50%. A considered reason for this is as follows: in the discharge cell that uses a long-afterglow phosphor, the shutter is gradually opened before the afterglow disappears even if the shutter is not sufficiently open at the occurrence time of the discharge, so that the emission luminance is kept by observation of the afterglow by the user.

In the present exemplary embodiment, the timing of starting the opening of a shutter is set in consideration of these phenomena.

Next, the specific control of right-eye shutter 52R and left-eye shutter 52L is described.

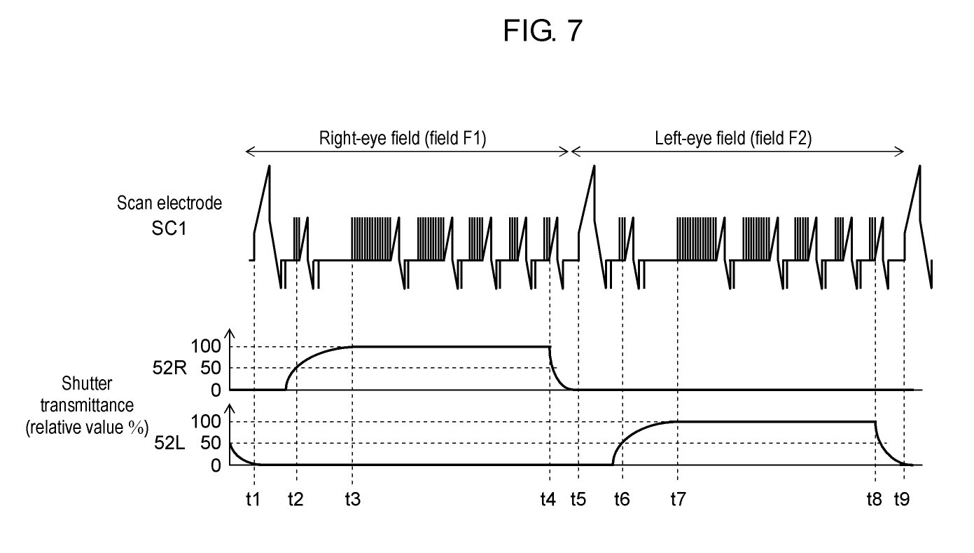

FIG. 7 is a diagram for schematically showing a subfield structure and an open/close state of right-eye shutter 52R and left-eye shutter 52L when a 3D image is displayed on plasma display apparatus 1 in accordance with the first exemplary embodiment of the present invention. FIG. 7 shows a driving voltage waveform applied to scan electrode SC1, and the open/close state of right-eye shutter 52R and left-eye shutter 52L of shutter glasses 50. FIG. 7 shows two fields (right-eye field F1 and left-eye field F3).

The diagram showing the open/close state of shutter glasses 50 of FIG. 7 shows the open/close state of right-eye shutter 52R and left-eye shutter 52L using the transmittance. In the diagram showing the opening or closing of the shutters of FIG. 7, the vertical axis relatively shows the transmittance of each shutter, assuming that the completely open state of the shutter has a transmittance of 100% (maximum transmittance) and the completely close state of the shutter has a transmittance of 0% (minimum transmittance). The horizontal axis shows time.

In the present exemplary embodiment, when the driver circuit of plasma display apparatus 1 performs 3D drive, control signal generation circuit 45 generates a shutter opening/closing timing signal so that, in both the right-eye filed and left-eye filed, both the right-eye shutter opening/closing timing signal and left-eye shutter opening/closing timing signal are at OFF in the all-cell initializing period of subfield SF1. Control signal generation circuit 45 also generates a shutter opening/closing timing signal so that the average value of the transmittance of the right-eye shutter 52R or left-eye shutter 52L is lower than 100% (e.g. about 50%) in the sustain period of subfield SF1.

Specifically, when each shutter of shutter glasses 50 is closed, control signal generation circuit 45 generates a shutter opening/closing timing signal so as to achieve the following phenomenon:
at time t1 (also t9) immediately before the start of the all-cell initializing operation of a right-eye field (e.g. field F1), left-eye shutter 52L that has been open until then is closed completely; and
in the all-cell initializing period of a right-eye field (e.g. field F1), both left-eye shutter 52L and right-eye shutter 52R have a transmittance of 0%.

Control signal generation circuit 45 generates a shutter opening/closing timing signal so as to achieve the following phenomenon:
at time t5 immediately before the start of the all-cell initializing operation of a left-eye field (e.g. field F2), right-eye shutter 52R that has been open until then is closed completely; and
in the all-cell initializing period of a left-eye field (e.g. field F2), both left-eye shutter 52L and right-eye shutter 52R have a transmittance of 0%.

When each shutter of shutter glasses 50 is opened, control signal generation circuit 45 generates a right-eye shutter opening/closing timing signal so as to achieve the following phenomenon:
at time t2, which is an intermediate time of the sustain period in subfield SF1 of a right-eye field (e.g. field F1), right-eye shutter 52R has a transmittance of about 50%; and
at time t3 immediately before the start of the sustain period of subfield SF2, the transmittance of right-eye shutter 52R is 90% or higher, preferably 100%.

Control signal generation circuit 45 generates a left-eye shutter opening/closing timing signal so as to achieve the following phenomenon:
at time t6, which is an intermediate time of the sustain period in subfield SF1 of a left-eye field (e.g. field F2), the transmittance of left-eye shutter 52L is about 50%; and
at time t7 immediately before the start of the sustain period of subfield SF2, the transmittance of left-eye shutter 52L is 90% or higher, preferably 100%.

A similar operation is repeated in each field.

Thus, control signal generation circuit 45 of the present exemplary embodiment generates a right-eye shutter opening/closing timing signal so as to achieve the following phenomenon in a right-eye field (e.g. field F1):
right-eye shutter 52R is close until the initializing period of subfield SF1 as the first subfield finishes;
right-eye shutter 52R is opened before the start of the sustain period of subfield SF1 so that the average value of the transmittance in the sustain period of subfield SF1 becomes lower than 100% (e.g. about 50%); and
right-eye shutter 52R is closed after the completion of the generation of a sustain pulse in the sustain period of the final subfield (e.g. subfield SF6).

Control signal generation circuit 45 generates a left-eye shutter opening/closing timing signal so as to achieve the following phenomenon in a left-eye field (e.g. field F2):
left-eye shutter 52L is close until the initializing period of subfield SF1 finishes;
left-eye shutter 52L is opened before the start of the sustain period of subfield SF1 so that the average value of the transmittance in the sustain period of subfield SF1 becomes lower than 100% (e.g. about 50%); and
left-eye shutter 52L is closed after the completion of the generation of a sustain pulse in the sustain period of the final subfield (e.g. subfield SF6).

In shutter glasses 50, the opening or closing of each shutter requires a period corresponding to the characteristics of the material (e.g. liquid crystal) of the shutter. Dependently on the material of the shutter, the opening or closing of the shutters requires a period longer than the above-mentioned one. In the present exemplary embodiment, when the shutter is closed, the timing of closing the shutter may be set so that the transmittance of the shutter is 30% or lower, preferably 10% or lower, immediately before the start of the all-cell initializing operation.

In the example of FIG. 7, control signal generation circuit 45 may generate a left-eye shutter opening/closing timing signal so as to achieve the following phenomenon:
at time t1 immediately before the start of the all-cell initializing operation in subfield SF1, which is the first subfield of a right-eye field (e.g. field F1), the transmittance of left-eye shutter 52L is 30% or lower, preferably 10% or lower.

Control signal generation circuit 45 may generate a right-eye shutter opening/closing timing signal so as to achieve the following phenomenon:
at time t5 immediately before the start of the all-cell initializing operation in subfield SF1, which is the first subfield of a left-eye field (e.g. field F2), the transmittance of right-eye shutter 52R is 30% or lower, preferably 10% or lower.

At this time, preferably, the period after the completion of the generation of a sustain pulse in the sustain period of the final subfield until the start of the all-cell initializing operation in the first subfield is set in consideration of the period after each shutter starts to be closed until it is closed completely.

In the example of FIG. 7, preferably, the interval between time t4 and time t5 is set so as to achieve the following phenomenon:
when right-eye shutter 52R starts to be closed at time t4 immediately after the completion of the generation of the sustain pulse in subfield SF6, which is the final subfield of a right-eye field (e.g. field F1), the transmittance of right-eye shutter 52R at least at time t5 is 30% or lower, preferably 10% or lower.

Similarly, preferably, the interval between time t8 and time t9 is set so as to achieve the following phenomenon:
when left-eye shutter 52L starts to be closed at time t8 immediately after the completion of the generation of the sustain pulse in subfield SF6, which is the final subfield of a left-eye field (e.g. field F2), the transmittance of left-eye shutter 52L is 30% or lower, preferably 10% or lower, at least at time t9 immediately before the start of the all-cell initializing operation of subfield SF1 of the subsequent right-eye field.

When each shutter is opened, the timing of opening the shutter is set so that the transmittance of the shutter is 70% or higher, preferably 90% or higher, immediately before the start of the sustain period of subfield SF2.

In the example of FIG. 7, preferably, the timing of opening the shutter is set so that the transmittance of right-eye shutter 52R is 70% or higher, preferably 90% or higher, at time t3 immediately before the generation of the sustain pulse in subfield SF2 of a right-eye field (e.g. field F1).

Preferably, the timing of opening the shutter is set so that the transmittance of left-eye shutter 52L is 70% or higher, preferably 90% or higher, at time t7 immediately before the generation of the sustain pulse in subfield SF2 of a left-eye field (e.g. field F2).

At this time, preferably, the period after the completion of subfield SF1 until the start of the sustain period of subfield SF2 is set in consideration of the period after each shutter starts to be opened until it is opened completely.

In the example of FIG. 7, the interval between time t2 and time t3 is set at least so that the transmittance of right-eye shutter 52R is 70% or higher, preferably 90% or higher, at time t3.

Similarly, the interval between time t6 and time t7 is set at least so that the transmittance of left-eye shutter 52L is 70% or higher, preferably 90% or higher, at time t7.

Thus, in the present exemplary embodiment, the opening/closing operation of each shutter is controlled in consideration of the period after each shutter starts to be closed until it is closed completely and the period after each shutter starts to be opened until it is opened completely.

The timing of switching the shutter opening/closing timing signal from ON to OFF, or from OFF to ON, is previously set in response to the characteristics of shutter glasses 50 and the structure of the field. Control signal generation circuit 45 generates a shutter opening/closing timing signal in response to the preset timing. The opening/closing operation of right-eye shutter 52R and left-eye shutter 52L of shutter glasses 50 is controlled based on ON or OFF of the shutter opening/closing timing signal output from timing signal output section 49 (right-eye shutter opening/closing timing signal and left-eye shutter opening/closing timing signal).

In the present exemplary embodiment, thus, by generating the shutter opening/closing timing signal, both right-eye shutter 52R and left-eye shutter 52L of shutter glasses 50 are close in the initializing period (all-cell initializing period) of the all-cell initializing subfield (subfield SF1) in both the right-eye field and left-eye field. Therefore, emitted light by the all-cell initializing operation can be blocked by right-eye shutter 52R and left-eye shutter 52L, and prevented from entering the eyes of the user. Therefore, a user who views a 3D image through shutter glasses 50 does not see the emitted light by the all-cell initializing operation and can observe the 3D image at the luminance of black level where the luminance corresponding to the light emission is reduced.

In the present exemplary embodiment, when a 3D image is displayed on panel 10, a shutter opening/closing timing signal is generated so that the average value of the transmittance of right-eye shutter 52R or left-eye shutter 52L of shutter glasses 50 becomes about 50%, for example, in the sustain period of subfield SF1. Thus, in the sustain period of subfield SF1, the timing of starting the opening of right-eye shutter 52R and left-eye shutter 52L can be made later than that when the shutter opening/closing timing signal is generated so that the average value of the transmittance of each shutter becomes 100%.

Thus, the period in which the afterglow is blocked by closing of both right-eye shutter 52R and left-eye shutter 52L is further extended, the afterglow from the previous field can be hardly seen, and the effect of reducing the crosstalk can be enhanced for a user who views a 3D image through shutter glasses 50.

When the transmittance of a shutter in the sustain period of subfield SF1 becomes 50%, for example, a user can sense the reduction in luminance of subfield SF1 in a discharge cell having a phosphor layer that uses a phosphor (short-afterglow phosphor) having afterglow characteristics of a small time constant.

A considered reason for this is as follows: in the discharge cell using a short-afterglow phosphor, the afterglow is small and the emitted light capable of being observed by a user is substantially the same as the emitted light during the occurrence of discharge, so that the emission luminance capable of being observed by the user decreases when the shutter is not sufficiently opened during the occurrence of discharge.

In the present exemplary embodiment, for example, as a phosphor forming phosphor layer 35G and phosphor layer 35R, a long-afterglow phosphor of an afterglow time constant of about 3 msec is used. For phosphor layer 35B, a short-afterglow phosphor of an afterglow time constant of about 0.1 msec is used.

Therefore, when the average value of the transmittance of the shutter in the sustain period of subfield SF1 becomes about 50%, the possibility that a user senses the reduction in luminance in a red discharge cell and green discharge cell is low, but there is a possibility that a user senses the reduction in luminance in a blue discharge cell is high.

When difference in emission luminance occurs between a discharge cell using a long-afterglow phosphor and a discharge cell using a short-afterglow phosphor, a user can sense the difference as variation in hue.

In order to address this problem, the number of sustain pulses to be generated is adjusted so as to compensate for the reduction in luminance. In other words, only in the discharge cell using a short-afterglow phosphor, the number of sustain pulses to be generated is increased so as to compensate for the reduction in emission luminance caused in the sustain period of subfield SF1.

In the case of the above-mentioned configuration, this problem can be addressed by forming a subfield where light is not emitted in the red discharge cell and green discharge cell but light is emitted only in the blue discharge cell. In the present exemplary embodiment, for example, subfield SF6 may be set as a subfield where light is not emitted in the red discharge cell and green discharge cell but light is emitted only in the blue discharge cell. This setting can compensate for the reduction in emission luminance caused in the sustain period of subfield SF1 in the discharge cell including a short-afterglow phosphor, and can prevent variation in hue.

In the present exemplary embodiment, a phosphor of an afterglow time constant of 1 msec or shorter is used as a short-afterglow phosphor, and a phosphor of an afterglow time constant longer than 1 msec is used as a long-afterglow phosphor. However, the present invention is not limited to these numerical values.

In the present exemplary embodiment, the example where the average value of the transmittance of the shutter is set at about 50% in the sustain period of subfield SF1 has been described. However, the present invention is not limited to these numerical values. For example in subfield SF1, by delaying the timing of opening the shutter, the transmittance of the shutter can be reduced to a degree that a user does not sense the reduction in luminance in the discharge cell having a phosphor layer including a long-afterglow phosphor. The timing of opening the shutter and the average value of the transmittance of the shutter in the sustain period of subfield SF1 are set in response to the afterglow characteristics of the phosphors, the characteristics of the panel, and the specification of the plasma display apparatus.

Next, the difference in emission luminance caused by variation in driving load is described.

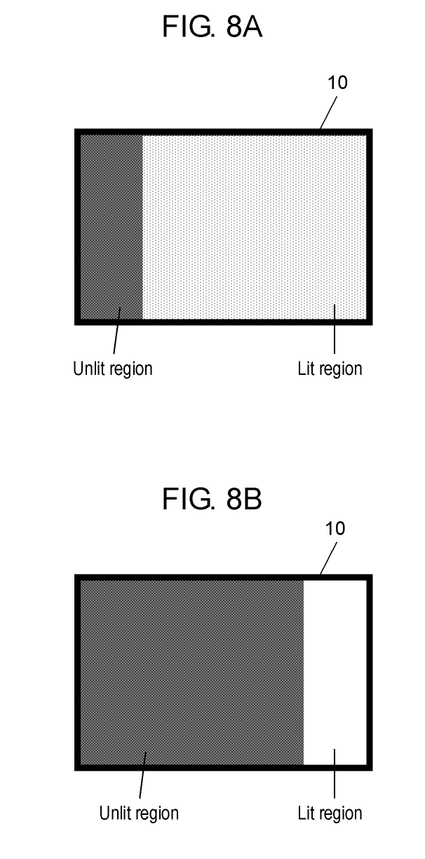

FIG. 8A and FIG. 8B are schematic diagrams for describing the difference in emission luminance caused by variation in driving load. FIG. 8A and FIG. 8B schematically show the light emission state of the image display region of panel 10 in a certain subfield. In these diagrams, each black region shows an unlit region where light is not emitted in the discharge cells, and each white region shows a lit region where light is emitted in the discharge cells. FIG. 8A is a diagram for schematically showing the light emission state of panel 10 when the lit region is set as 80% of the image display region of panel 10. FIG. 8B is a diagram for schematically showing the light emission state of panel 10 when the lit region is set as 20% of the image display region of panel 10. In FIG. 8A and FIG. 8B, it is assumed that display electrode pairs 24 are extended in the row direction (horizontally in the diagrams) similarly to panel 10 of FIG. 2.

When light is emitted on panel 10 while the area of the lit region is altered as shown in FIG. 8A and FIG. 8B, emission luminance in the lit region varies. A considered reason for this is described below.

Display electrode pairs 24 are extended in the row direction (horizontally in the diagrams) as discussed above. Therefore, when light is emitted on panel 10 while the area of the lit region is altered as shown in FIG. 8A and FIG. 8B, the number of lit cells occurring on display electrode pairs 24 varies. As the lit region becomes narrow, the number of lit cells occurring on display electrode pairs 24 decreases. Therefore, the driving load is smaller in display electrode pairs 24 having the light emission state shown in FIG. 8B than in display electrode pairs 24 having the light emission state shown in FIG. 8A.

Therefore, voltage drop of the driving voltage, for example voltage drop of the sustain pulse, is smaller in display electrode pairs 24 having the light emission state shown in FIG. 8B than in display electrode pairs 24 having the light emission state shown in FIG. 8A. In other words, the discharge intensity of the sustain discharge in the lit region shown in FIG. 8B is stronger than that of the sustain discharge in the lit region shown in FIG. 8A. As a result, the emission luminance is higher in the lit region shown in FIG. 8B than in the lit region shown in FIG. 8A.

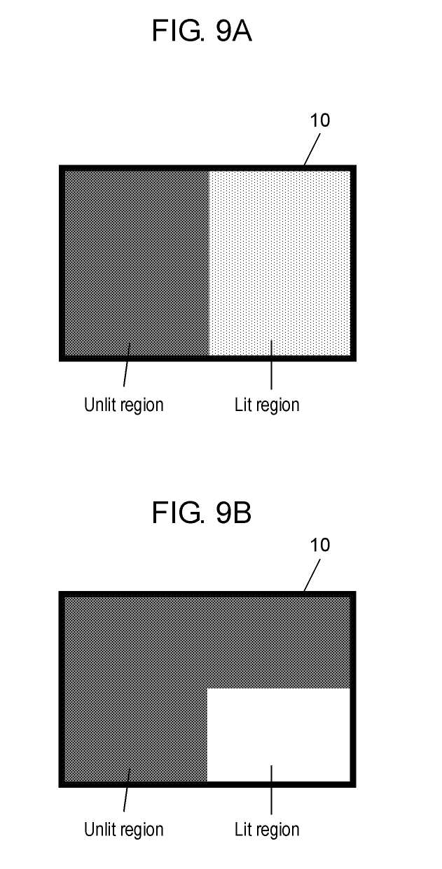

FIG. 9A and FIG. 9B are schematic diagrams for describing another example of the difference in emission luminance caused by variation in driving load. FIG. 9A and FIG. 9B schematically show the light emission state of the image display region of panel 10 in a certain subfield. In these diagrams, each black region shows an unlit region where light is not emitted in the discharge cells, and each white region shows a lit region where light is emitted in the discharge cells. FIG. 9A is a diagram for schematically showing the light emission state of panel 10 when the lit region is set as 50% of the image display region of panel 10. FIG. 9B is a diagram for schematically showing the light emission state of panel 10 when the lit region is set as 25% of the image display region of panel 10.

In the present exemplary embodiment, as discussed above, “average value of partial light-emitting rates” is calculated except for the partial light-emitting rate that is a partial light-emitting rate threshold (e.g. 0%) or lower. In FIG. 9B, display electrode pairs 24 in a half of the image display region are not lit. The partial light-emitting rate in display electrode pairs 24 in a remaining half of the image display region is 50%. Therefore, the average value of the partial light-emitting rates in FIG. 9B is 50%. The partial light-emitting rate in each display electrode pair 24 in the image display region is 50% in FIG. 9A, so that the average value of the partial light-emitting rates in FIG. 9A is 50%. Therefore, the average values of the partial light-emitting rates in FIG. 9A and FIG. 9B are 50%, and are equal to each other.

FIG. 8A and FIG. 8B show an example where the driving load of display electrode pairs 24 in the lit region, namely the partial light-emitting rate, varies. As shown in FIG. 9A and FIG. 9B, however, even when the average value of the partial light-emitting rates in the lit region does not vary, the emission luminance in the lit region varies when the total number of lit cells, namely the all-cell light-emitting rate, varies. This is considered to be mainly because sustain electrode driver circuit 44 are connected to all sustain electrodes 23 in parallel as discussed above and all sustain electrodes 23 are driven collectively, and hence the voltage drop of the output voltage from sustain electrode driver circuit 44 is varied by variation in all-cell light-emitting rate.

In other words, in order to accurately estimate the variation in emission luminance in lit cells, preferably, both the all-cell light-emitting rate and the partial light-emitting rates (in the present exemplary embodiment, average value of partial light-emitting rates) on panel 10 are detected.

Thus, in the present exemplary embodiment, the all-cell light-emitting rate and the average value of the partial light-emitting rates are detected for each subfield. The number of sustain pulses to be generated in one sustain period is altered based on the detection result, the luminance generated in the one sustain period is controlled, and the luminance of each subfield is kept at a predetermined brightness. The luminance generated in the one sustain period means a luminance obtained by accumulating emitted light generated by sustain discharge in the one sustain period. Thus, the linearity of the gradation in the display image is kept, and the image display quality can be improved.

In the present exemplary embodiment, the number of sustain pulses to be generated set based on the input image signal and luminance weight is corrected using a correction coefficient that is determined based on the all-cell light-emitting rate and the average value of the partial light-emitting rates, and the number of sustain pulses to be generated is controlled by generating as many sustain pulses as the number corresponding to the correction result. Next, one example of a setting method of the correction coefficient is described.

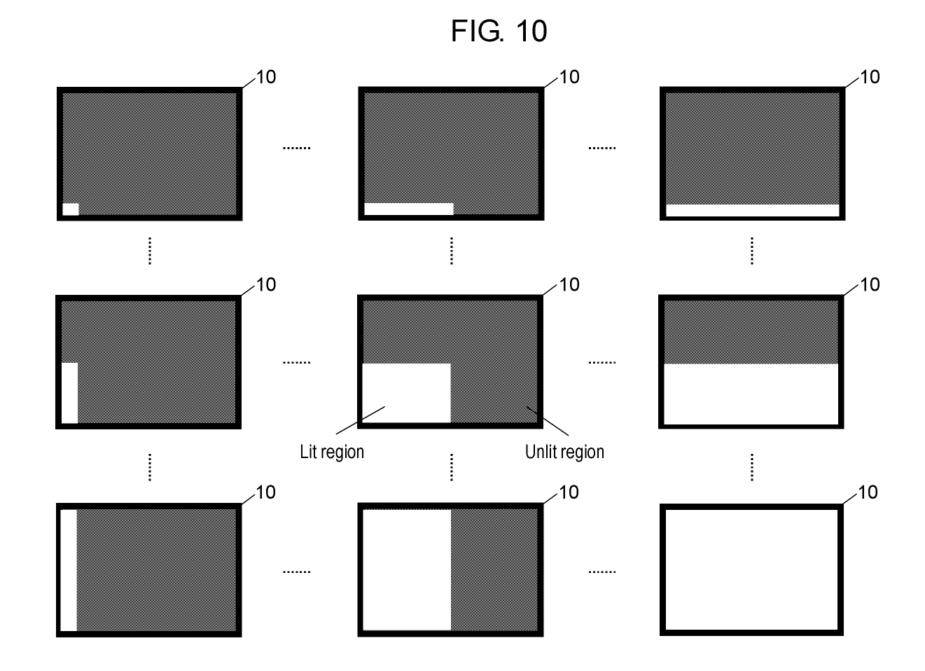

FIG. 10 is a diagram for schematically showing the measurement of emission luminance performed for setting the correction coefficient in accordance with the first exemplary embodiment of the present invention. In the present exemplary embodiment, in order to set the correction coefficient, an image that is partitioned into two, namely a lit region and an unlit region, is firstly displayed on panel 10 as shown in FIG. 10, and the emission luminance is measured while the lit region is gradually enlarged.

For example, an image is displayed where the length of the row direction (horizontal direction in FIG. 10) and the length of the column direction (vertical direction in FIG. 10) of the lit region are set at 10% of those of the image display region of panel 10, and the emission luminance of the lit region is measured. Thus, the emission luminance of the image where the all-cell light-emitting rate is 1% and the average value of the partial light-emitting rates is 10% can be acquired.

Next, an image is displayed where the length of the row direction of the lit region is 10% of that of the image display region of panel 10 and the length of the column direction of the lit region is 20% of that of the image display region, and the emission luminance of the lit region is measured. Thus, the emission luminance of the image where the all-cell light-emitting rate is 2% and the average value of the partial light-emitting rates is 10% can be acquired.

Similarly, the emission luminance is measured while the lit region is gradually enlarged. By repeating the measurement, respective emission luminances of a plurality of images having different all-cell light-emitting rate and different average value of partial light-emitting rates can be acquired.

Then, a reference emission luminance is set at “1”, and each emission luminance is normalized. For example, the emission luminance when the all-cell light-emitting rate and the average value of the partial light-emitting rates are 100% is assumed to be the reference emission luminance, and each emission luminance is normalized. The inverse of each numerical value is calculated. In the present exemplary embodiment, the inverse is set as the correction coefficient.

For example, it is assumed that the emission luminance is set at “1” when the all-cell light-emitting rate and the average value of the partial light-emitting rates are 100%. When the emission luminance is “1.25” for an all-cell light-emitting rate of 5% and an average value of partial light-emitting rates of 40%, the inverse of “1.25”, namely “0.80”, is set as the correction coefficient for an all-cell light-emitting rate of 5% and an average value of partial light-emitting rates of 40%.

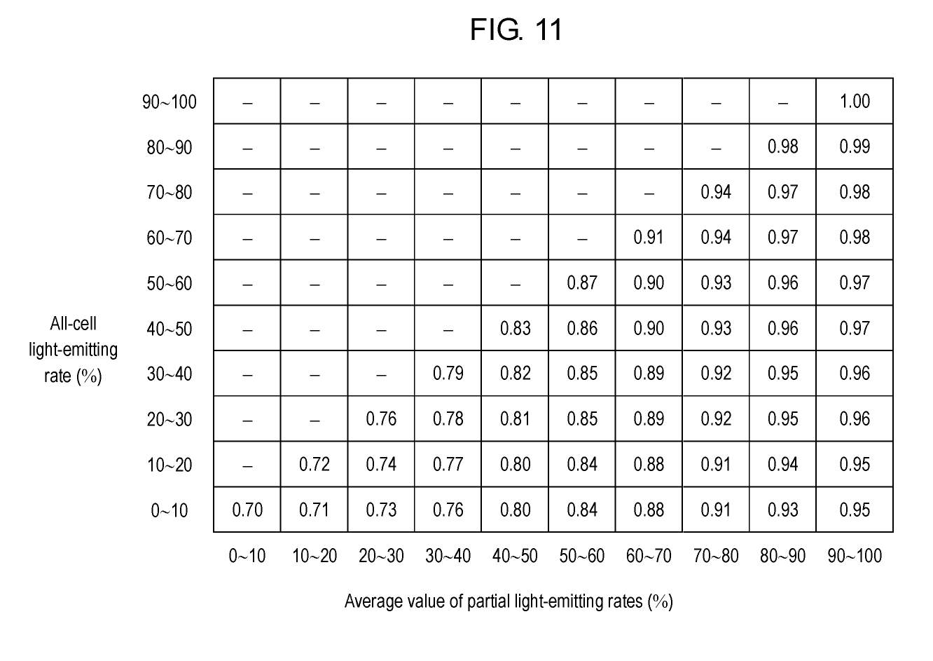

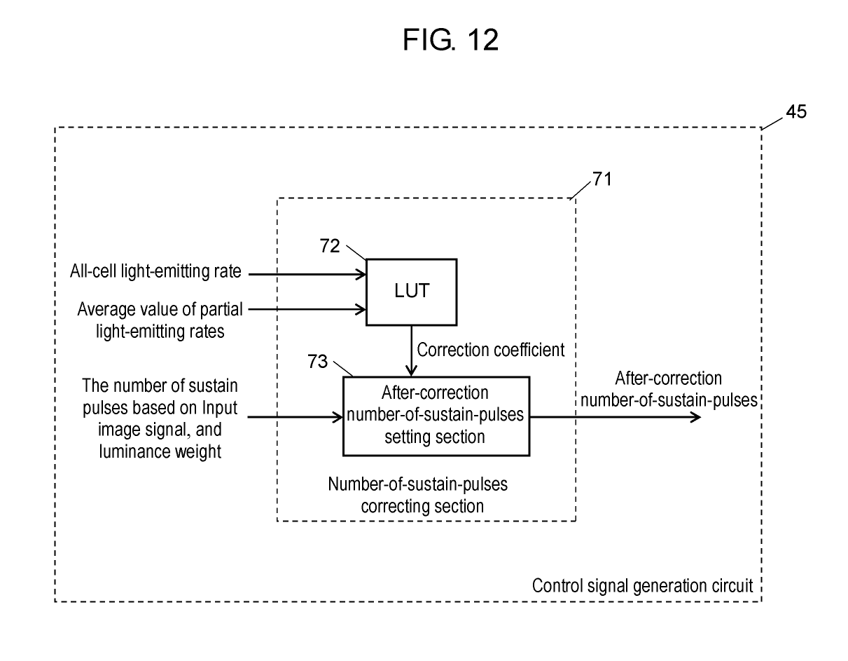

FIG. 11 is a diagram showing one example of the correction coefficients in accordance with the first exemplary embodiment of the present invention. FIG. 12 is a diagram showing one example of circuit blocks of number-of-sustain-pulses correcting section 71 in accordance with the first exemplary embodiment of the present invention. FIG. 12 shows only circuit blocks related to number-of-sustain-pulses correcting section 71, and omits the other circuit blocks.

As shown in FIG. 12, control signal generation circuit 45 of the present exemplary embodiment includes number-of-sustain-pulses correcting section 71. Number-of-sustain-pulses correcting section 71 has look-up table 72 (“LUT” in FIG. 12) and after-correction number-of-sustain-pulses setting section 73.

Look-up table 72 is formed of a circuit element (e.g. semiconductor storage element) that stores a plurality of data segments and reads the data optionally. Look-up table 72 can store a plurality of correction coefficients and can read one correction coefficient based on the all-cell light-emitting rate and the average value of the partial light-emitting rates.

After-correction number-of-sustain-pulses setting section 73 multiplies the number (hereinafter, simply referred to as “number of sustain pulses”) of sustain pulses to be generated set based on the input image signal and luminance weight by the correction coefficient read from look-up table 72, and outputs the multiplication result as the number of sustain pulses after correction.

Then, control signal generation circuit 45 generates a control signal for controlling each circuit block so that as many sustain pulses as the number of sustain pulses after correction output from after-correction number-of-sustain-pulses setting section 73 are output from sustain pulse generation circuit 60 and sustain pulse generation circuit 80.

In FIG. 11, the all-cell light-emitting rate (0% to 100%) is divided into 10 stages by 10%, the average value (0% to 100%) of the partial light-emitting rates is divided into 10 stages by 10% for each stage of the all-cell light-emitting rate, and a correction coefficient corresponding to each stage of the all-cell light-emitting rate and each stage of the average value of partial light-emitting rates is shown. When the all-cell light-emitting rate is 100% for example, the average value of the partial light-emitting rates is not lower than 100%. Combinations that do not substantially occur are denoted with “-” in FIG. 11.

FIG. 11 shows simply one example. The dividing manners of the all-cell light-emitting rate and the average value of partial light-emitting rates of the present invention are not limited to the dividing manners shown in FIG. 11. Each correction coefficient is not limited to the numerical value of FIG. 11.

In the present exemplary embodiment, as shown in FIG. 11, the correction coefficients acquired by the above-mentioned method are expressed by a matrix in association with the all-cell light-emitting rate and the average value of the partial light-emitting rates. The matrix is stored on look-up table 72. From the plurality of correction coefficients stored on look-up table 72, one correction coefficient is read based on the all-cell light-emitting rate and the average value of the partial light-emitting rates detected for each subfield. Then, the number of sustain pulses to be generated in the subfield is corrected using the read correction coefficient.

The example of the correction coefficients of FIG. 11 is described below.

When the average value of the partial light-emitting rates is 0% or higher and lower than 10% and the all-cell light-emitting rate is 0% or higher and lower than 10%, the correction coefficient is 0.70.

When the average value of the partial light-emitting rates is 10% or higher and lower than 20%, the correction coefficient is 0.71 when the all-cell light-emitting rate is 0% or higher and lower than 10%, and 0.72 when the all-cell light-emitting rate is 10% or higher and lower than 20%.

When the average value of the partial light-emitting rates is 20% or higher and lower than 30%, the correction coefficient is 0.73 when the all-cell light-emitting rate is 0% or higher and lower than 10%, 0.74 when the all-cell light-emitting rate is 10% or higher and lower than 20%, and 0.76 when the all-cell light-emitting rate is 20% or higher and lower than 30%.

When the average value of the partial light-emitting rates is 30% or higher and lower than 40%, the correction coefficient is 0.76 when the all-cell light-emitting rate is 0% or higher and lower than 10%, 0.77 when the all-cell light-emitting rate is 10% or higher and lower than 20%, 0.78 when the all-cell light-emitting rate is 20% or higher and lower than 30%, and 0.79 when the all-cell light-emitting rate is 30% or higher and lower than 40%.

When the average value of the partial light-emitting rates is 40% or higher and lower than 50%, the correction coefficient is 0.80 when the all-cell light-emitting rate is 0% or higher and lower than 20%, 0.81 when the all-cell light-emitting rate is 20% or higher and lower than 30%, 0.82 when the all-cell light-emitting rate is 30% or higher and lower than 40%, and 0.83 when the all-cell light-emitting rate is 40% or higher and lower than 50%.

When the average value of the partial light-emitting rates is 50% or higher and lower than 60%, the correction coefficient is 0.84 when the all-cell light-emitting rate is 0% or higher and lower than 20%, 0.85 when the all-cell light-emitting rate is 20% or higher and lower than 40%, 0.86 when the all-cell light-emitting rate is 40% or higher and lower than 50%, and 0.87 when the all-cell light-emitting rate is 50% or higher and lower than 60%.

When the average value of the partial light-emitting rates is 60% or higher and lower than 70%, the correction coefficient is 0.88 when the all-cell light-emitting rate is 0% or higher and lower than 20%, 0.89 when the all-cell light-emitting rate is 20% or higher and lower than 40%, 0.90 when the all-cell light-emitting rate is 40% or higher and lower than 60%, and 0.91 when the all-cell light-emitting rate is 60% or higher and lower than 70%.

When the average value of the partial light-emitting rates is 70% or higher and lower than 80%, the correction coefficient is 0.91 when the all-cell light-emitting rate is 0% or higher and lower than 20%, 0.92 when the all-cell light-emitting rate is 20% or higher and lower than 40%, 0.93 when the all-cell light-emitting rate is 40% or higher and lower than 60%, and 0.94 when the all-cell light-emitting rate is 60% or higher and lower than 80%.

When the average value of the partial light-emitting rates is 80% or higher and lower than 90%, the correction coefficient is 0.93 when the all-cell light-emitting rate is 0% or higher and lower than 10%, 0.94 when the all-cell light-emitting rate is 10% or higher and lower than 20%, 0.95 when the all-cell light-emitting rate is 20% or higher and lower than 40%, 0.96 when the all-cell light-emitting rate is 40% or higher and lower than 60%, 0.97 when the all-cell light-emitting rate is 60% or higher and lower than 80%, and 0.98 when the all-cell light-emitting rate is 80% or higher and lower than 90%.

When the average value of the partial light-emitting rates is 90% or higher, the correction coefficient is 0.95 when the all-cell light-emitting rate is 0% or higher and lower than 20%, 0.96 when the all-cell light-emitting rate is 20% or higher and lower than 40%, 0.97 when the all-cell light-emitting rate is 40% or higher and lower than 60%, 0.98 when the all-cell light-emitting rate is 60% or higher and lower than 80%, 0.99 when the all-cell light-emitting rate is 80% or higher and lower than 90%, and 1.00 when the all-cell light-emitting rate is 90% or higher.

For example, it is assumed that the number of sustain pulses to be generated set based on the input image signal and luminance weight in subfield SF2 is “128”. It is also assumed that the all-cell light-emitting rate in subfield SF2 is 5% and the average value of the partial light-emitting rates is 45%. In this case, the correction coefficient acquired from the data of look-up table 72 of FIG. 11 is “0.80”. Therefore, after-correction number-of-sustain-pulses setting section 73 multiplies “128” by “0.80”, and sets the number of sustain pulses to be generated in subfield SF2 at “102”. Thus, the luminance of subfield SF2 is set at 80% of that when the number of sustain pulses to be generated is set at “128”.

The luminance of subfield SF2 when the all-cell light-emitting rate is 5% and the average value of the partial light-emitting rates is 45% is 1/0.80=1.25 times that when the all-cell light-emitting rate of subfield SF2 is 100% (here, the number of sustain pulses to be generated is kept at “128”). Therefore, when the number of sustain pulses to be generated in subfield SF2 is set at “102”, which is 20% smaller than “128”, the luminance of subfield SF2 can be equal to the luminance when the number of sustain pulses to be generated in subfield SF2 is “128” and the all-cell light-emitting rate is 100%.

In the present exemplary embodiment, thus, the luminance of each subfield can be always equal to a predetermined luminance regardless of the lit state of the discharge cell, by correcting the number of sustain pulses to be generated set based on the input image signal and luminance weight using a correction coefficient that is determined based on the all-cell light-emitting rate and the average value of the partial light-emitting rates in each subfield. For example, the predetermined luminance is the luminance when the all-cell light-emitting rate is 100% and the number of sustain pulses to be generated is set based on the input image signal and luminance weight.

In the present exemplary embodiment, as discussed above, a shutter opening/closing timing signal is generated so that the average value of the transmittance of the shutters in the sustain period of subfield SF1 is lower than 100% (e.g. about 50%). Therefore, when the number of sustain pulses to be generated in the sustain period of subfield SF1 varies, a user who views a 3D image through shutter glasses 50 can feel as if difference in emission luminance occurred between a discharge cell using a long-afterglow phosphor and a discharge cell using a short-afterglow phosphor. When difference in emission luminance occurs between the discharge cell using the long-afterglow phosphor and the discharge cell using the short-afterglow phosphor, the user senses the difference as variation in hue.

In the present exemplary embodiment, in order to prevent such variation in hue, the correction of the number of sustain pulses to be generated based on the all-cell light-emitting rate and the average value of the partial light-emitting rates is not performed in the first subfield, namely subfield SF1, of the field when a 3D image is displayed on panel 10.

When the number of sustain pulses to be generated in the sustain period of the final subfield (e.g. subfield SF6) of the field increases, the timing that the sustain period of the final subfield is completed is delayed. Therefore, the afterglow leaking to the field immediately after it can increase to degrade the crosstalk.

In the present exemplary embodiment, in order to prevent the degradation of the crosstalk, the correction of the number of sustain pulses to be generated based on the all-cell light-emitting rate and the average value of the partial light-emitting rates is not performed also in the final subfield of the field when a 3D image is displayed on panel 10.

As discussed above, in the present exemplary embodiment, the variation in emission luminance in each subfield is accurately estimated by detecting the all-cell light-emitting rate and the average value of the partial light-emitting rate in each subfield. Then, a plurality of preset correction coefficients is stored on look-up table 72 in association with the all-cell light-emitting rate and the average value of the partial light-emitting rates. One correction coefficient is read from look-up table 72 based on the all-cell light-emitting rate and the average value of the partial light-emitting rates detected for each subfield. Then, using the read correction coefficient, after-correction number-of-sustain-pulses setting section 73 corrects the number of sustain pulses to be generated set based on the input image signal and luminance weight. Since the luminance of each subfield can be thus kept at a predetermined luminance, the linearity of gradation in a display image can be kept and the image display quality can be enhanced. The predetermined luminance is, for example, the luminance when the all-cell light-emitting rate is 100% and the number of sustain pulses to be generated is set based on the input image signal and luminance weight.

When a 3D image is displayed on panel 10, shutter glasses 50 are controlled so as to achieve the following phenomenon:
both right-eye shutter 52R and left-eye shutter 52L are close in the all-cell initializing period of subfield SF1 in both the right-eye field and the left-eye field; and
the average value of the transmittance of the shutters in the sustain period of subfield SF1 is lower than 100% (e.g. about 50%).
   Thus, a user who views the 3D image on panel 10 through shutter glasses 50 can be prevented from observing emitted light generated by the all-cell initializing operation of subfield SF1. Therefore, satisfactory luminance of black level whose luminance is reduced by a value corresponding to this emitted light by the initializing discharge can be achieved, and the contrast of the 3D image can be sharpened. This configuration can reduce the afterglow leaking into the next field and suppress the crosstalk comparing with the configuration where shutter glasses 50 are controlled so that the shutters are completely opened when the sustain period of subfield SF1 is started.

In addition, when a 3D image is displayed on panel 10, the subfields are restricted where the number of sustain pulses to be generated is corrected using the correction coefficient that is determined based on the all-cell light-emitting rate and the average value of the partial light-emitting rates. Specifically, in the first subfield and final subfield of a field, the control for correcting the number of sustain pulses to be generated is not performed. In other words, when a 3D image is displayed on panel 10, the number of sustain pulses to be generated is corrected using the correction coefficient that is determined based on the all-cell light-emitting rate and the average value of the partial light-emitting rates in the subfields other than the first subfield and final subfield of the field.

Thus, a user who views a 3D image on panel 10 through shutter glasses 50 can obtain a high-quality 3D image where the linearity of gradation in the display image can be kept and variation in hue and degradation of crosstalk are prevented from being observed.

In the present exemplary embodiment, the luminance weights of the first subfield and final subfield of a field are set at “1”, and are smaller than those of the other subfields. Thus, even when the number of sustain pulses to be generated is not corrected in the first subfield and final subfield of the field, the effect on the linearity of gradation in the display image is small and substantially present no problem. In other words, in order to reduce the effect on the linearity of gradation in the display image, preferably, as small luminance weights as possible are assigned to the first subfield and final subfield of the field. For example, preferably, the smallest luminance weight and the second-smallest luminance weight are assigned to the first subfield and final subfield of the field.

When the crosstalk due to afterglow presents no problem, shutter glasses 50 may be controlled by generating a shutter opening/closing timing signal so that the average value of the transmittance of the shutters in the sustain period of subfield SF1 is 100%. In this case, however, the hue does not vary even when the number of sustain pulses to be generated in subfield SF1 is corrected, so that control of correcting the number of sustain pulses to be generated in subfield SF1 may be performed based on the all-cell light-emitting rate and the average value of the partial light-emitting rates.

### Second Exemplary Embodiment

As the screen of panel 10 is enlarged and the definition is enhanced, inter-electrode capacity Cp of panel 10 is increased. The increase in inter-electrode capacity Cp increases the reactive power which is consumed ineffectively without contributing on the light emission when panel 10 is driven, and hence becomes one factor of increasing the power consumption.

On panel 10 where the driving impedance is increased by the enlargement of the panel and the enhancement of the definition, waveform distortion such as ringing is apt to occur in a driving waveform. Therefore, fluctuation in discharge is apt to increase and fluctuation in luminance called luminance non-uniformity is apt to occur.

At this time, for example, the length of at least one of the following periods is altered:
the period (hereinafter referred to as “rising period”) in which power recovery circuit 61 and power recovery circuit 81 are operated to raise a sustain pulse; and
the period (hereinafter referred to as “falling period”) in which power recovery circuit 61 and power recovery circuit 81 are operated to drop a sustain pulse.
   Further, the period (hereinafter referred to as “overlap period”) in which the rising period and falling period of a sustain pulse are made to overlap each other is altered in response to the display image. Thus, the sustain discharge can be stabilized while the power consumption by panel 10 is reduced.

In the present exemplary embodiment, a plurality of sustain pulses between which the length of at least one of the rising period and falling period differs from those of another sustain pulse is generated. A plurality of driving patterns between which the combination of the sustain pulses to be generated and the length of “overlap period” are different is set, the patterns are switched appropriately in response to the display image, and sustain pulses are generated. Here, the driving patterns are the following six driving patterns: a first driving pattern, second driving pattern, third driving pattern, fourth driving pattern, fifth driving pattern, and sixth driving pattern, for example.

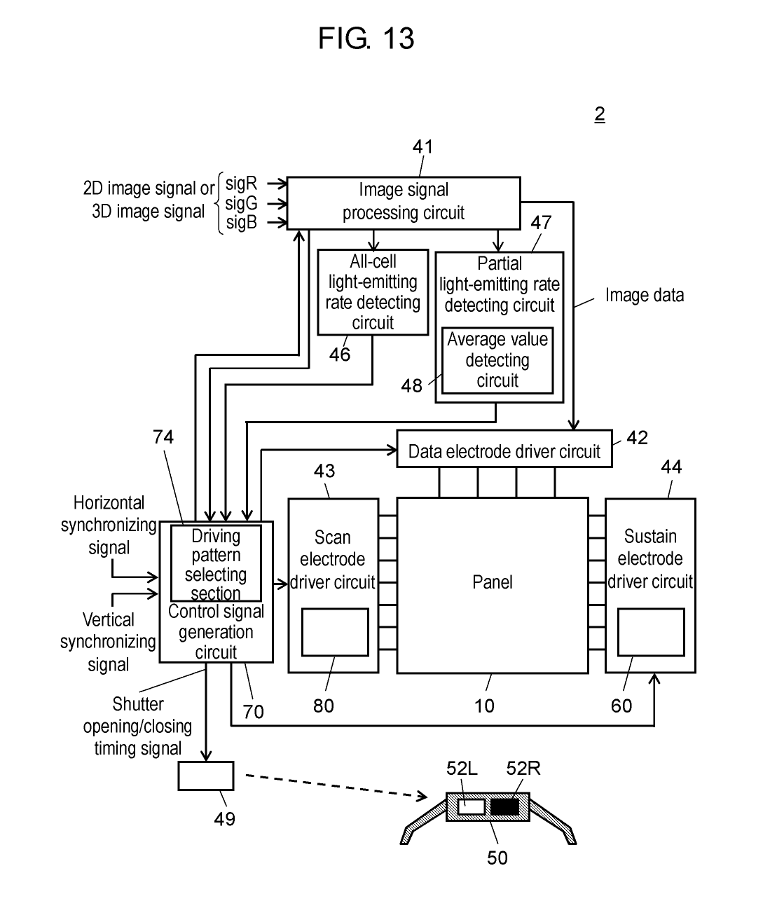

FIG. 13 is a circuit block diagram of plasma display apparatus 2 in accordance with the second exemplary embodiment of the present invention. Plasma display apparatus 2 has a configuration similar to that of plasma display apparatus 1 shown in FIG. 3 except that control signal generation circuit 70 has driving pattern selecting section 74.

Driving pattern selecting section 74 selects one of the plurality of driving patterns based on the outputs from all-cell light-emitting rate detecting circuit 46 and partial light-emitting rate detecting circuit 47. Control signal generation circuit 70 outputs a control signal for controlling sustain pulse generation circuit 60 and sustain pulse generation circuit 80 so that sustain pulses are generated based on the selection result.

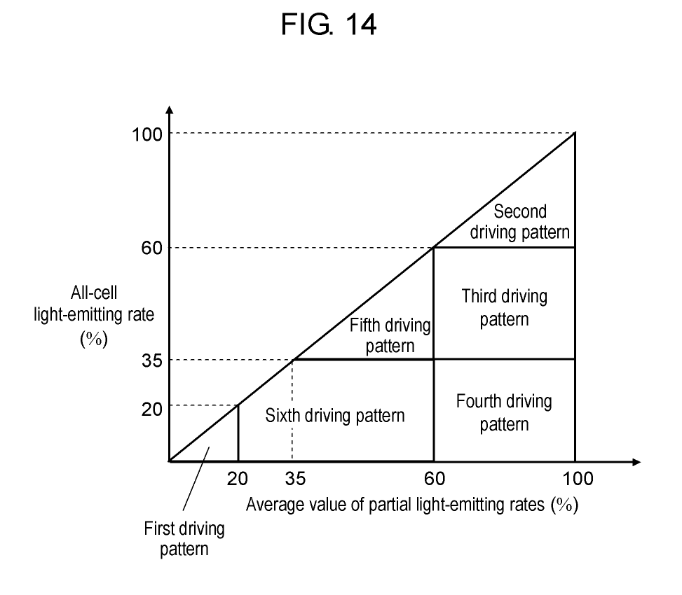

FIG. 14 is a diagram showing one example of the relationship between the all-cell light-emitting rate, the average value of the partial light-emitting rates, and switching of the driving patterns in accordance with the second exemplary embodiment of the present invention. In FIG. 14, the horizontal axis shows the average value of the partial light-emitting rates, and the vertical axis shows the all-cell light-emitting rate.

In the present exemplary embodiment, in a subfield where the average value of the partial light-emitting rates is low and the all-cell light-emitting rate is low, sustain pulses are generated in the first driving pattern. In the example shown in FIG. 14, sustain pulses are generated in the first driving pattern in the subfield where the average value of the partial light-emitting rates is lower than 20% and the all-cell light-emitting rate is lower than 20%.

The first driving pattern is used for improving the emission luminance. In the first driving pattern, the emission luminance is improved in a subfield where the all-cell light-emitting rate is low and the average value of the partial light-emitting rates is low, namely in a subfield where the lit region is small and the driving load of panel 10 is low.

In a subfield where the average value of the partial light-emitting rates is high and the all-cell light-emitting rate is high, sustain pulses are generated in the second driving pattern. In the example shown in FIG. 14, sustain pulses are generated in the second driving pattern in a subfield where the average value of the partial light-emitting rates is 60% or higher and the all-cell light-emitting rate is 60% or higher.

The second driving pattern is used for improving the luminous efficiency. In the second driving pattern, the luminous efficiency is improved to reduce the power consumption in a subfield where the all-cell light-emitting rate is high and the average value of the partial light-emitting rates is high, namely in a subfield where the lit region is large as a whole and the driving load of panel 10 is high as a whole.

In a subfield where the average value of the partial light-emitting rates is high and the all-cell light-emitting rate is in a predetermined range, sustain pulses are generated in the third driving pattern. In the example shown in FIG. 14, sustain pulses are generated in the third driving pattern in a subfield where the average value of the partial light-emitting rates is 60% or higher and the all-cell light-emitting rate is 35% or higher and lower than 60%.

The third driving pattern is used for improving the emission luminance and luminous efficiency. In the third driving pattern, the emission luminance is improved and the luminous efficiency is improved to reduce the power consumption in a subfield where the all-cell light-emitting rate is relatively high and the average value of the partial light-emitting rates is high, namely in a subfield where a part of the image display region is a lit region and the driving load of panel 10 is partially high.

In a subfield where the average value of the partial light-emitting rates is high and the all-cell light-emitting rate is low, sustain pulses are generated in the fourth driving pattern. In the example shown in FIG. 14, sustain pulses are generated in the fourth driving pattern in a subfield where the average value of the partial light-emitting rates is 60% or higher and the all-cell light-emitting rate is lower than 35%.

The fourth driving pattern is used for improving the emission luminance while enhancing the effect of improving the luminous efficiency. In the fourth driving pattern, the emission luminance is improved and the luminous efficiency is improved to reduce the power consumption in a subfield where the all-cell light-emitting rate is low and the average value of the partial light-emitting rates is high, namely in a subfield where the lit region is centered on a part of the image display region and the driving load of panel 10 is extremely high in part.

In a subfield where the average value of the partial light-emitting rates is intermediate and the all-cell light-emitting rate is also intermediate, sustain pulses are generated in the fifth driving pattern. In the example shown in FIG. 14, sustain pulses are generated in the fifth driving pattern in a subfield where the average value of the partial light-emitting rates is 35% or higher and lower than 60% and the all-cell light-emitting rate is 35% or higher and lower than 60%.

The fifth driving pattern is used for improving the luminous efficiency while enhancing the effect of improving the emission luminance. In the fifth driving pattern, the luminous efficiency is improved to reduce the power consumption and the emission luminance is improved in a subfield where the all-cell light-emitting rate is intermediate and the average value of the partial light-emitting rates is also intermediate, namely in a subfield where the lit region is slightly dispersed in the image display region, the region having high driving load on panel 10 is not unbalanced comparing with that when the third driving pattern is applied, and the driving load is intermediate as a whole.

In a subfield where the average value of the partial light-emitting rates is intermediate and the all-cell light-emitting rate is low, sustain pulses are generated in the sixth driving pattern. In the example shown in FIG. 14, sustain pulses are generated in the sixth driving pattern in a subfield where the average value of the partial light-emitting rates is 20% or higher and lower than 60% and the all-cell light-emitting rate is lower than 35%. This lit state occurs most frequently when a typical moving image is displayed.

The sixth driving pattern is used for most enhancing the effect of improving the luminous efficiency. In the sixth driving pattern, the effect of improving the luminous efficiency is enhanced to reduce the power consumption in a subfield where the all-cell light-emitting rate is low and the average value of the partial light-emitting rates is intermediate, namely in a subfield where the lit region is dispersed in the image display region, the region having high driving load on panel 10 is not unbalanced comparing with that when the fourth driving pattern is applied, and the driving load is low as a whole.

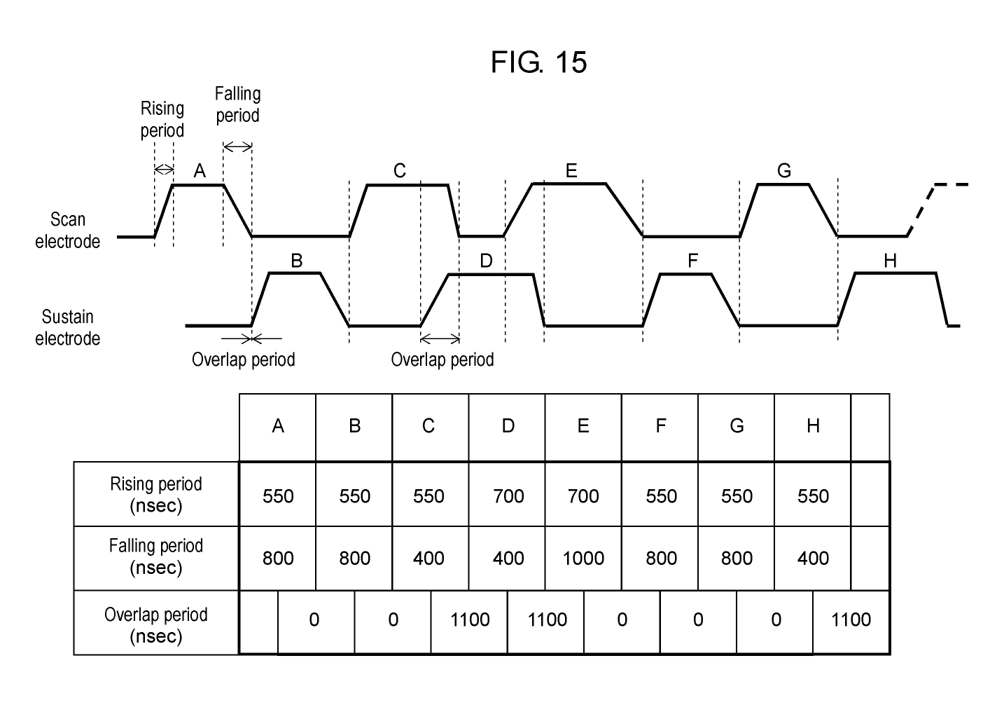

Next, the details of respective driving patterns are described using FIG. 15 through FIG. 20.

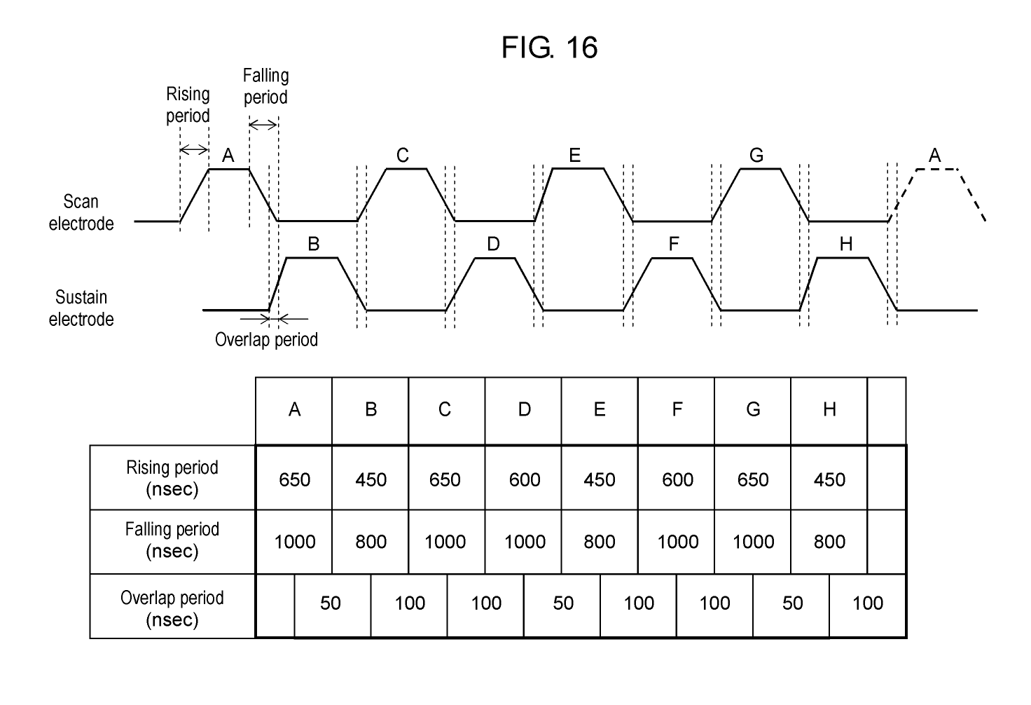

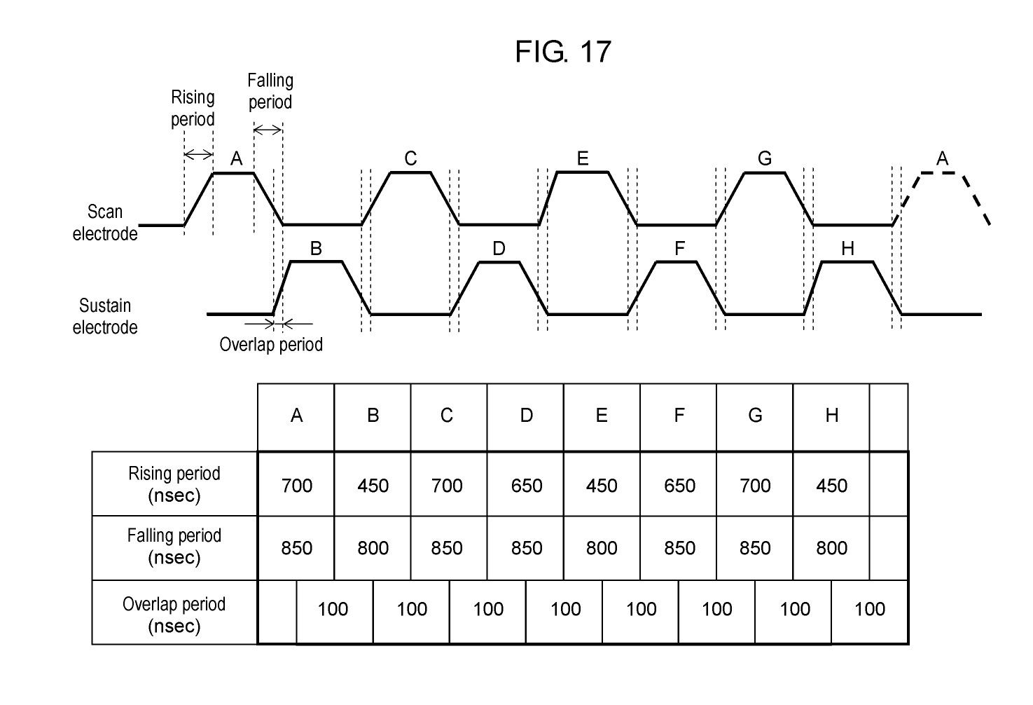

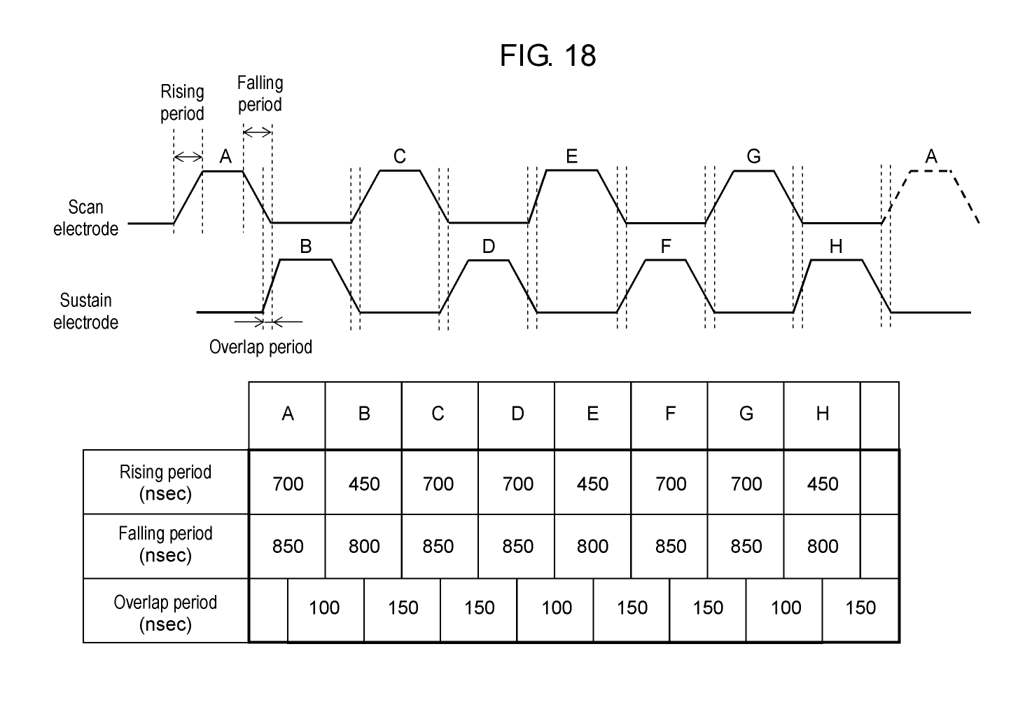

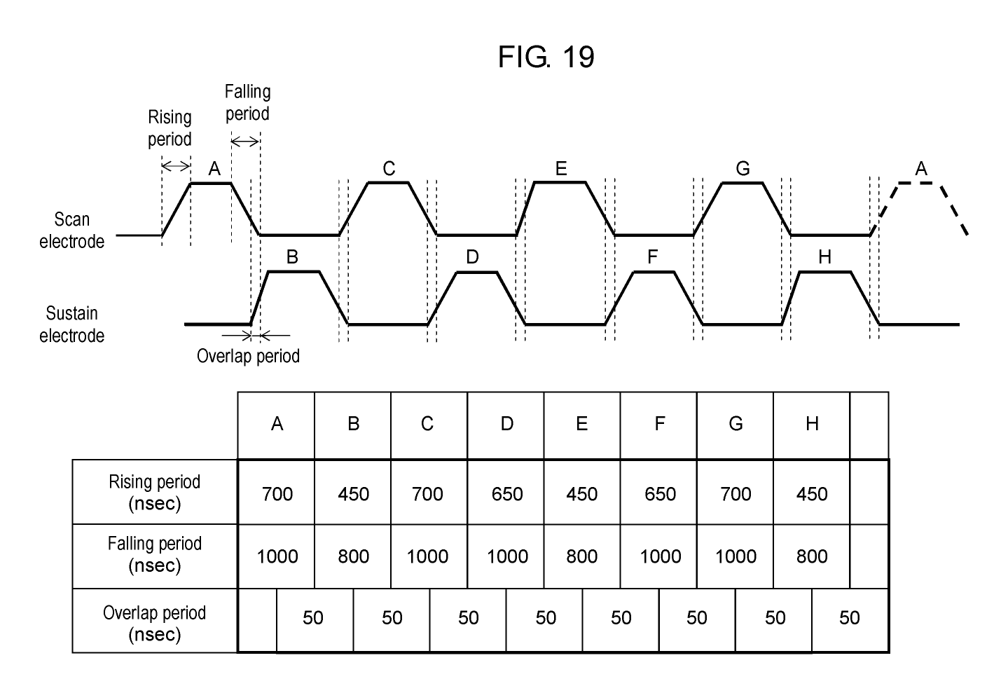

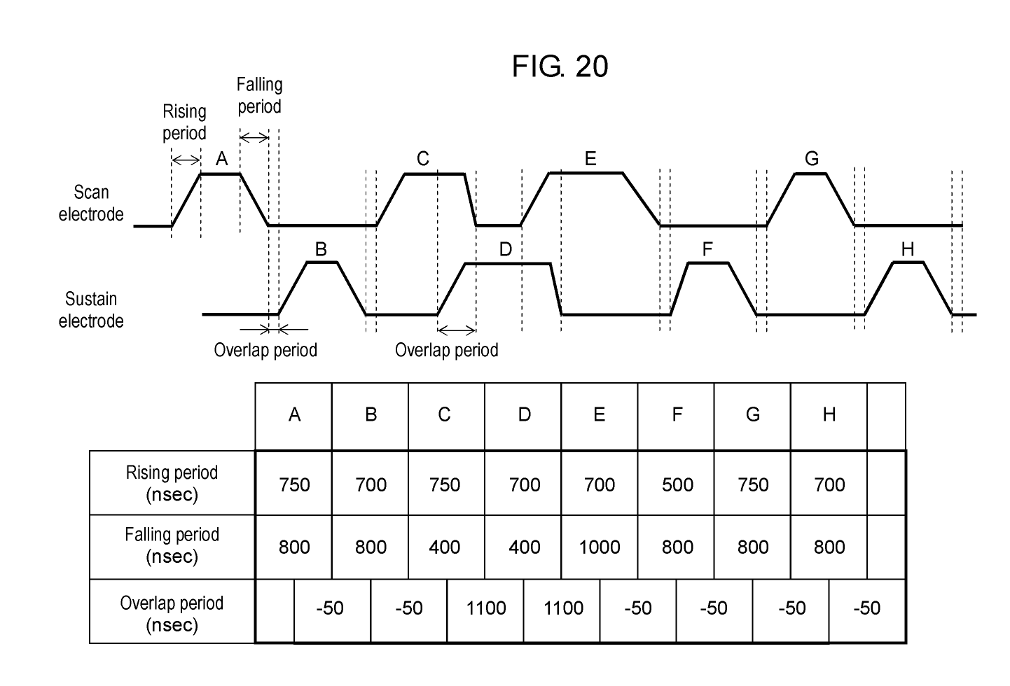

FIG. 15 is a schematic waveform chart of the sustain pulses generated in the first driving pattern in accordance with the second exemplary embodiment of the present invention. FIG. 16 is a schematic waveform chart of the sustain pulses generated in the second driving pattern in accordance with the second exemplary embodiment of the present invention. FIG. 17 is a schematic waveform chart of the sustain pulses generated in the third driving pattern in accordance with the second exemplary embodiment of the present invention. FIG. 18 is a schematic waveform chart of the sustain pulses generated in the fourth driving pattern in accordance with the second exemplary embodiment of the present invention. FIG. 19 is a schematic waveform chart of the sustain pulses generated in the fifth driving pattern in accordance with the second exemplary embodiment of the present invention. FIG. 20 is a schematic waveform chart of the sustain pulses generated in the sixth driving pattern in accordance with the second exemplary embodiment of the present invention.

In FIG. 15 through FIG. 20, the upper part of each diagram schematically shows the waveform of sustain pulses, and the lower part shows specific numerical values of “rising period”, “falling period”, and “overlap period”. In “overlap period” having a minus numerical value, both scan electrode 22 and sustain electrode 23 are set at 0 (V). In the sustain pulses shown in each of FIG. 15 through FIG. 20, the period after the application of one sustain pulse to scan electrode 22 is started until the application of one sustain pulse to sustain electrode 23 is completed is set at about 5.4 μsec, and the resonance cycle of power recovery circuit 61 and power recovery circuit 81 is set at 1600 nsec.

In the first driving pattern, as shown in FIG. 15, “rising period” is set at 550 nsec and “falling period” is set at 800 nsec in the first sustain pulse (A in FIG. 15) and the second sustain pulse (B). “Rising period” is set at 550 nsec and “falling period” is set at 400 nsec in the third sustain pulse (C). “Rising period” is set at 700 nsec and “falling period” is set at 400 nsec in the fourth sustain pulse (D). “Rising period” is set at 700 nsec and “falling period” is set at 1000 nsec in the fifth sustain pulse (E).

In the first driving pattern, in FIG. 15, the sixth sustain pulse (F) is equal to the first sustain pulse (A), the seventh sustain pulse (G) is equal to the second sustain pulse (B), and the eighth sustain pulse (H) is equal to the third sustain pulse (C).

“Overlap period” is set at 1100 nsec or 0 nsec. Specifically, as shown in FIG. 15, “overlap period” between the falling period of the third sustain pulse (C) having a steep falling gradient and the rising period of the fourth sustain pulse (D) and “overlap period” between the falling period of the fourth sustain pulse (D) having a steep falling gradient and the rising period of the fifth sustain pulse (E) are set at 1100 nsec. The other “overlap periods” are set at 0 nsec. In the first driving pattern, sustain pulses having a steep falling gradient are generated so that a part having “overlap period” of 1100 nsec occurs about twice per five times. In the first driving pattern, sustain pulses are generated by repeating a pattern constituted by five sustain pulses of A through E of FIG. 15.

In the second driving pattern, as shown in FIG. 16, “rising period” is set at 650 nsec and “falling period” is set at 1000 nsec in the first sustain pulse (A in FIG. 16), the third sustain pulse (C), and the seventh sustain pulse (G). “Rising period” is set at 450 nsec and “falling period” is set at 800 nsec in the second sustain pulse (B), the fifth sustain pulse (E), and the eighth sustain pulse (H). “Rising period” is set at 600 nsec and “falling period” is set at 1000 nsec in the fourth sustain pulse (D) and the sixth sustain pulse (F).

“Overlap period” is set at 50 nsec or 100 nsec as shown in FIG. 16. In the second driving pattern, sustain pulses are generated by repeating a pattern constituted by eight sustain pulses of A through H of FIG. 16.

In the third driving pattern, as shown in FIG. 17, “rising period” is set at 700 nsec and “falling period” is set at 850 nsec in the first sustain pulse (A in FIG. 17), the third sustain pulse (C), and the seventh sustain pulse (G). “Rising period” is set at 450 nsec and “falling period” is set at 800 nsec in the second sustain pulse (B), the fifth sustain pulse (E), and the eighth sustain pulse (H). “Rising period” is set at 650 nsec and “falling period” is set at 850 nsec in the fourth sustain pulse (D) and the sixth sustain pulse (F).

“Overlap period” is set at 100 nsec as shown in FIG. 17. In the third driving pattern, sustain pulses are generated by repeating a pattern constituted by eight sustain pulses of A through H of FIG. 17.

In the fourth driving pattern, as shown in FIG. 18, “rising period” is set at 700 nsec and “falling period” is set at 850 nsec in the first sustain pulse (A in FIG. 18), the third sustain pulse (C), the fourth sustain pulse (D), the sixth sustain pulse (F), and the seventh sustain pulse (G). “Rising period” is set at 450 nsec and “falling period” is set at 800 nsec in the second sustain pulse (B), the fifth sustain pulse (E), and the eighth sustain pulse (H).

“Overlap period” is set at 100 nsec or 150 nsec as shown in FIG. 18. In the fourth driving pattern, sustain pulses are generated by repeating a pattern constituted by eight sustain pulses of A through H of FIG. 18.

In the fifth driving pattern, as shown in FIG. 19, “rising period” is set at 700 nsec and “falling period” is set at 1000 nsec in the first sustain pulse (A in FIG. 19), the third sustain pulse (C), and the seventh sustain pulse (G). “Rising period” is set at 450 nsec and “falling period” is set at 800 nsec in the second sustain pulse (B), the fifth sustain pulse (E), and the eighth sustain pulse (H). “Rising period” is set at 650 nsec and “falling period” is set at 1000 nsec in the fourth sustain pulse (D) and the sixth sustain pulse (F).

“Overlap period” is set at 50 nsec as shown in FIG. 19. In the fifth driving pattern, sustain pulses are generated by repeating a pattern constituted by eight sustain pulses of A through H of FIG. 19.

In the sixth driving pattern, as shown in FIG. 20, “rising period” is set at 750 nsec and “falling period” is set at 800 nsec in the first sustain pulse (A in FIG. 20) and the seventh sustain pulse (G). “Rising period” is set at 700 nsec and “falling period” is set at 800 nsec in the second sustain pulse (B) and the eighth sustain pulse (H). “Rising period” is set at 750 nsec and “falling period” is set at 400 nsec in the third sustain pulse (C). “Rising period” is set at 700 nsec and “falling period” is set at 400 nsec in the fourth sustain pulse (D). “Rising period” is set at 700 nsec and “falling period” is set at 1000 nsec in the fifth sustain pulse (E). “Rising period” is set at 500 nsec and “falling period” is set at 800 nsec in the sixth sustain pulse (F).

“Overlap period” is set at 1100 nsec or −50 nsec. Specifically, as shown in FIG. 20, “overlap period” between the falling period of the third sustain pulse (C) having a steep falling gradient and the rising period of the fourth sustain pulse (D) and “overlap period” between the falling period of the fourth sustain pulse (D) having a steep falling gradient and the rising period of the fifth sustain pulse (E) are set at 1100 nsec. The other “overlap periods” are set at −50 nsec. In other words, the period in which both scan electrode 22 and sustain electrode 23 are at 0 (V) is set at 50 nsec. In the sixth driving pattern, sustain pulses having a steep falling gradient are generated so that a part having “overlap period” of 1100 nsec occurs about twice per eight times. In the sixth driving pattern, sustain pulses are generated by repeating a pattern constituted by eight sustain pulses of A through H of FIG. 20.

Sustain pulses are generated while these six driving patterns are switched in response to the all-cell light-emitting rate and the average value of the partial light-emitting rates, thereby driving panel 10. Thus, it can be confirmed that an average reduction of the power consumption is about 10 to 30 W in typical moving image display, though this effect depends on the pattern of the display image. Further, the improvement of the image display quality due to the effect of reducing the fluctuation in discharge can be confirmed.

Thus, in such a configuration where panel 10 is driven by generating sustain pulses while the driving patterns are switched adaptively, an effect of reducing the power consumption and fluctuation in discharge can be produced. However, when a sustain pulse is generated, the waveform of the sustain pulse differs between the driving patterns and hence the waveform differs between subfields. Therefore, luminance difference caused by the difference between the waveforms of the sustain pulse can occur between the subfields. As a result, the emission luminance differs between the subfields, and the linearity of the gradation can be damaged.

In the present exemplary embodiment, when the correction coefficients of the number of sustain pulses to be generated shown in the first exemplary embodiment are calculated, the emission luminance is measured in consideration of the difference between the driving patterns. In other words, when a plurality of images between which the all-cell light-emitting rate and the average value of partial light-emitting rates are different is displayed on panel 10, panel 10 is driven by generating sustain pulses while the driving patterns are switched in response to the all-cell light-emitting rate and the average value of the partial light-emitting rates, and the emission luminance is measured.

Thus, as shown in the present exemplary embodiment, even in the configuration where panel 10 is driven while the driving patterns are switched adaptively in response to the lit state of the image, the correction coefficients can be set in consideration of the variation in emission luminance due to the difference between the driving patterns.

For example, when sustain pulses are generated using the sixth driving pattern for enhancing the effect of improving the luminous efficiency, the effect of reducing the power consumption can be enhanced, but the emission luminance can reduce. Even in this case, the number of sustain pulses to be generated can be corrected (increased, in this case) and the emission luminance can be restored when the correction coefficients are previously set in consideration of the variation in emission luminance due to the difference between the driving patterns.

Thus, in the present exemplary embodiment, sustain pulses are generated while the driving patterns are switched in response to the lit state. Thus, the sustain discharge can be stably caused while the power consumption on panel 10 is reduced.

In the present exemplary embodiment, when the correction coefficients of the number of sustain pulses to be generated are calculated, the emission luminance is measured in consideration of the variation in emission luminance due to the difference between the driving patterns.

Thus, the correction coefficients can be set in consideration of the difference between the emission luminances that is caused by the difference in driving load between subfields in one sustain discharge and the difference between the emission luminances that is caused by the difference between the driving patterns. Therefore, even in plasma display apparatus 2 for generating sustain pulses while switching the driving patterns in response to the lit state, the luminance of each subfield can be always kept at a predetermined luminance. The predetermined luminance is, for example, the luminance when the all-cell light-emitting rate is 100% and the number of sustain pulses to be generated is set based on the input image signal and luminance weight.

Thus, in the present exemplary embodiment, even in plasma display apparatus 2 for generating sustain pulses while the driving patterns are switched in response to the lit state in order to produce the effect of reducing the power consumption and the effect of reducing the fluctuation discharge, the linearity of gradation in the display image can be kept and the image display quality can be improved.

The structure of each driving pattern of the present exemplary embodiment is simply one example, and is appropriately set at the optimal structure. For example, in the second driving pattern through sixth driving pattern, the structures where sustain pulses are generated by repeating one pattern constituted by eight sustain pulses have been described. One pattern may be constituted by more sustain pulses or less sustain pulses. The structure may be set optionally in response to the specification of plasma display apparatus 2. For example, all sustain pulses may have the same waveform in a subfield where the total number of sustain pulses is smaller than the number of sustain pulses constituting one pattern.

The resonance cycle and the pulse width of the sustain pulses are not limited to the above-mentioned numerical values, and, preferably, each set value is set optimally in response to the characteristics of panel 10 and the specification of plasma display apparatus 2.

In the present exemplary embodiment of the present invention, the configuration has been described where each correction coefficient is set while the maximum value of the correction coefficients is assumed to be “1”. This configuration is simply one example that is effective when the total period required for each subfield arrives at about one-field period and it is therefore difficult to increase the number of sustain pulses by extending the sustain period. There is a case where the total period required for each subfield is shorter than one-field period and the number of sustain pulses can be increased by extending the sustain period, for example a case where the luminance magnification is small. In such a case, plasma display apparatus 1 may have the following configuration: each correction coefficient is set so that the maximum value of the correction coefficients is larger than “1”, and a subfield is generated where the number of sustain pulses to be generated is increased by correction. In any configuration, preferably, each correction coefficient is set so that the total period required for each subfield after the correction does not exceed one-field period.

In the present exemplary embodiments of the present invention, the configuration has been described where the luminance weight of the final subfield is set at a numerical value equal to that of subfield SF1. However, the present invention is not limited to this configuration.

In the present exemplary embodiments of the present invention, the configuration where a correction coefficient is selected from look-up table 72 has been described. However, a configuration where plasma display apparatus 1 does not have look-up table 72 may be employed. For example, the following configuration may be employed: an arithmetic circuit is configured so as to produce an effect similar to that when look-up table 72 is used, the arithmetic circuit is used to perform an operation preset based on the all-cell light-emitting rate and the average value of the partial light-emitting rates, and the correction coefficients are calculated.

In the present exemplary embodiments of the present invention, the following configuration has been described: a long-afterglow phosphor of a time constant of about 3 msec is used for phosphor layer 35R and phosphor layer 35G, and a short-afterglow phosphor of a time constant of about 0.1 msec is used for phosphor layer 35B. However, the present invention is not limited to this configuration. For example, a configuration may be employed where a long-afterglow phosphor is used for phosphor layer 35G and phosphor layer 35B and a short-afterglow phosphor is used for phosphor layer 35R. Alternatively, a configuration may be employed where a long-afterglow phosphor is used for phosphor layer 35R and phosphor layer 35B and a short-afterglow phosphor is used for phosphor layer 35G. Alternatively, a configuration may be employed where a long-afterglow phosphor is used for one of phosphor layer 35R, phosphor layer 35G, and phosphor layer 35B and a short-afterglow phosphor is used for the remaining two phosphor layers.

In the present exemplary embodiments of the present invention, the following configuration has been described: the shape of the driving voltage waveform applied to scan electrodes 22 in the all-cell initializing operation during 3D drive is equal to that of the driving voltage waveform applied to scan electrodes 22 in the all-cell initializing operation during 2D drive. However, the present invention is not limited to this configuration. For example, the gradient of the up-ramp voltage in the all-cell initializing operation during 3D drive may be steeper than that of the up-ramp voltage in the all-cell initializing operation during 2D drive. Alternatively, the gradient of the down-ramp voltage in the all-cell initializing operation during 3D drive may be steeper than that of the down-ramp voltage in the all-cell initializing operation during 2D drive. Thus, a configuration can be employed where the gradient of the ramp voltage is made steeper and the all-cell initializing operation during 3D drive is performed.

In the present exemplary embodiments of the present invention, the following configuration has been described: the value of voltage V12 during 3D drive is equal to that of voltage V12 during 2D drive. However, these voltage values may be different from each other.

The driving voltage waveforms shown in FIG. 5, FIG. 6, FIG. 7, FIG. 15, FIG. 16, FIG. 17, FIG. 18, FIG. 19, and FIG. 20 are simply one example in the present exemplary embodiment of the present invention. The present invention is not limited to these driving voltage waveforms. The circuit configurations of FIG. 3, FIG. 4, FIG. 12, and FIG. 13 are simply one example in the present exemplary embodiment of the present invention. The present invention is not limited to these circuit configurations.

FIG. 6 and FIG. 7 show the example where down-ramp voltages are generated and applied to scan electrode SC1 through scan electrode SCn in the period after the completion of subfield SF6 until the start of subfield SF1. However, a configuration where these down-ramp voltages are not generated may be employed. For example, in the period after the completion of subfield SF6 until the start of subfield SF1, scan electrode SC1 through scan electrode SCn, sustain electrode SU1 through sustain electrode SUn, and data electrode D1 through data electrode Dm are kept at 0 (V).

In the exemplary embodiments of the present invention, one field is constituted by eight subfields during 2D drive and one field is constituted by six subfields during 3D drive. In the present invention, however, the number of subfields constituting one field is not limited to these numbers. For example, by increasing the number of subfields, the number of gradations capable of being displayed on panel 10 can be increased.

In the exemplary embodiments of the present invention, the following example has been described:
the luminance weights of subfield SF1 through subfield SF8 are set at (1, 2, 4, 8, 16, 32, 64, 128) during 2D drive; and
the luminance weights of subfield SF1 through subfield SF6 are set at (1, 17, 8, 4, 2, 1) during 3D drive.
   However, the luminance weights of the subfields are not limited to these numerical values. When the combination of the subfields for determining the gradation is made flexible, for example, the luminance weights of subfield SF1 through subfield SF6 are set at (1, 12, 7, 3, 2, 1) or the like during 3D drive, the coding for suppressing occurrence of the moving image false contour is allowed. The number of subfields constituting one field and the luminance weights of the subfields are set appropriately in response to the characteristics of panel 10 and the specification of the plasma display apparatus.

Each circuit block shown in the exemplary embodiments of the present invention may be configured as an electric circuit for performing each operation shown in the exemplary embodiments, or may be configured using a microcomputer or the like programmed so as to perform a similar operation.

In the embodiments of the present invention, an example where one pixel is formed of discharge cells of three colors R, G, and B has been described. However, also in a panel where one pixel is formed of discharge cells of four or more colors, the configuration shown in the present embodiment of the present invention can be applied and a similar effect can be produced.

Each specific numerical value shown in the exemplary embodiments of the present invention is set based on the characteristics of panel 10 having a screen size of 50 inches and having 1024 display electrode pairs 24, and is simply one example in the embodiments. The present invention is not limited to these numerical values. Numerical values are preferably set optimally in response to the characteristics of the panel or the specification of the plasma display apparatus. These numerical values can vary in a range allowing the above-mentioned effect. The number of subfields constituting one field and the luminance weight of each subfield are not limited to the values shown in the exemplary embodiments of the present invention, but the subfield structure may be changed based on an image signal or the like.

### INDUSTRIAL APPLICABILITY

For a user who views a 3D image through shutter glasses, the plasma display apparatus having a 3D image display function of the present invention displays a 3D image where crosstalk occurring between a right-eye image and left-eye image is reduced while the linearity of the gradation in the display image is kept, thereby improving the image display quality. Therefore, the present invention is useful as a plasma display apparatus, a plasma display system, and a driving method of a panel.

### REFERENCE MARKS IN THE DRAWINGS

1, 2 plasma display apparatus
10 panel
21 front substrate
22 scan electrode
23 sustain electrode
24 display electrode pair
25, 33 dielectric layer
26 protective layer
31 rear substrate
32 data electrode
34 barrier rib
35, 35R, 35G, 35B phosphor layer
41 image signal processing circuit
42 data electrode driver circuit
43 scan electrode driver circuit
44 sustain electrode driver circuit
45, 70 control signal generation circuit
46 all-cell light-emitting rate detecting circuit
47 partial light-emitting rate detecting circuit
48 average value detecting circuit
49 timing signal output section
50 shutter glasses
52R right-eye shutter
52L left-eye shutter
60, 80 sustain pulse generation circuit
61, 81 power recovery circuit
62, 82 clamping circuit
71 number-of-sustain-pulses correcting section
72 look-up table
73 after-correction number-of-sustain-pulses setting section
74 driving pattern selecting section
C10, C20, C30 capacitor
L10, L20 inductor
Q11, Q12, Q13, Q14, Q21, Q22, Q23, Q24, Q26, Q27, Q28, Q29 switching element
D11, D12, D21, D22, D30 diode
Cp inter-electrode capacity
VS, VE1, ΔVE power supply
L1, L2, L4 ramp voltage
L3 erasing ramp voltage

1. A plasma display apparatus comprising:
a plasma display panel having a plurality of discharge cells each of which includes a display electrode pair formed of a scan electrode and a sustain electrode; and
a driver circuit that forms one field using a plurality of subfields having a sustain period in which a luminance weight is set, and displays an image on the plasma display panel by alternately repeating a right-eye field for displaying a right-eye image signal and a left-eye field for displaying a left-eye image signal based on an image signal having the right-eye image signal and the left-eye image signal,
wherein the driver circuit includes:
a sustain pulse generation circuit for generating as many sustain pulses as the number corresponding to the luminance weight in the sustain period, and alternately applying the sustain pulses to the scan electrodes and the sustain electrodes of the display electrode pairs;
a control signal generation circuit for generating a shutter opening/closing timing signal and a control signal that controls the sustain pulse generation circuit, the shutter opening/closing timing signal having a right-eye timing signal that becomes ON when the right-eye field is displayed on the plasma display panel and becomes OFF when the left-eye field is displayed and a left-eye timing signal that becomes ON when the left-eye field is displayed and becomes OFF when the right-eye field is displayed;
an all-cell light-emitting rate detecting circuit for detecting, as an all-cell light-emitting rate, the ratio of the number of discharge cells to be lit to the number of discharge cells in the image display region of the plasma display panel in each subfield; and
a partial light-emitting rate detecting circuit for dividing the image display region of the plasma display panel into a plurality of regions, and for detecting, as a partial light-emitting rate, the ratio of the number of discharge cells to be lit to the number of discharge cells in each of the regions in each subfield, and
wherein the driver circuit corrects the number of sustain pulses to be generated in each of the subfields in response to the all-cell light-emitting rate and the partial light-emitting rate, and the sustain pulse generation circuit generates as many sustain pulses as the corrected number.

2. The plasma display apparatus of claim 1, wherein
the driver circuit corrects the number of sustain pulses to be generated in response to the all-cell light-emitting rate and the partial light-emitting rates in the subfields other than the first subfield and the final subfield of a field.

3. The plasma display apparatus of claim 2, wherein
the driver circuit sets the first subfield to have a smallest luminance weight, and sets the final subfield to have the same luminance weight as that of the first subfield or a second-smallest luminance weight.

4. The plasma display apparatus of claim 1, wherein
the driver circuit calculates an average value of the partial light-emitting rates in the regions where the partial light-emitting rates exceed a predetermined threshold in each subfield, and
the driver circuit corrects the number of sustain pulses to be generated in response to the all-cell light-emitting rate and the average value of the partial light-emitting rates in the subfields other than the first subfield and the final subfield of a field.

5. The plasma display apparatus of claim 1, wherein
the driver circuit sets one display electrode pair as one region and detects the partial light-emitting rate in each of the display electrode pairs.

6. The plasma display apparatus of claim 1, wherein
the driver circuit generates a plurality of sustain pulses between which length of at least one of rising period and falling period differs from those of another sustain pulse, and
the driver circuit selects one driving pattern from a plurality of driving patterns, each of which has a different combination of the sustain pulses to be generated, in response to the all-cell light-emitting rate and the partial light-emitting rates, and generates the sustain pulses.

7. A plasma display system comprising:
a plasma display apparatus including:
a plasma display panel having a plurality of discharge cells each of which includes a display electrode pair formed of a scan electrode and a sustain electrode; and
a driver circuit that forms one field using a plurality of sub fields having a sustain period in which a luminance weight is set, and displays an image on the plasma display panel by alternately repeating a right-eye field for displaying a right-eye image signal and a left-eye field for displaying a left-eye image signal based on an image signal having the right-eye image signal and the left-eye image signal; and
shutter glasses that include a right-eye shutter and a left-eye shutter that can be independently opened or closed and control the opening/closing of the shutters in response to a shutter opening/closing timing signal generated by a control signal generation circuit,
wherein the driver circuit includes:
a sustain pulse generation circuit for generating as many sustain pulses as the number corresponding to the luminance weight in the sustain period, and alternately applying the sustain pulses to the scan electrodes and the sustain electrodes of the display electrode pairs;
a control signal generation circuit for generating a shutter opening/closing timing signal and a control signal that controls the sustain pulse generation circuit, the shutter opening/closing timing signal having a right-eye timing signal that becomes ON when the right-eye field is displayed on the plasma display panel and becomes OFF when the left-eye field is displayed and a left-eye timing signal that becomes ON when the left-eye field is displayed and becomes OFF when the right-eye field is displayed;
an all-cell light-emitting rate detecting circuit for detecting, as an all-cell light-emitting rate, the ratio of the number of discharge cells to be lit to the number of discharge cells in the image display region of the plasma display panel in each subfield; and
a partial light-emitting rate detecting circuit for dividing the image display region of the plasma display panel into a plurality of regions, and for detecting, as a partial light-emitting rate, the ratio of the number of discharge cells to be lit to the number of discharge cells in each of the regions in each subfield, and
wherein the driver circuit corrects the number of sustain pulses to be generated in response to the all-cell light-emitting rate and the partial light-emitting rates in the subfields other than the first subfield and the final subfield of a field, and the sustain pulse generation circuit generates as many sustain pulses as the corrected number.

8. A driving method of a plasma display panel having a plurality of discharge cells each of which includes a display electrode pair formed of a scan electrode and a sustain electrode, the driving method comprising:
forming one field using a plurality of subfields having a sustain period in which a luminance weight is set, and displaying an image on the plasma display panel by alternately repeating a right-eye field for displaying a right-eye image signal and a left-eye field for displaying a left-eye image signal based on an image signal having the right-eye image signal and the left-eye image signal;
detecting, as an all-cell light-emitting rate, the ratio of the number of discharge cells to be lit to the number of discharge cells in the image display region of the plasma display panel in each subfield;
dividing the image display region of the plasma display panel into a plurality of regions, and detecting, as a partial light-emitting rate, the ratio of the number of discharge cells to be lit to the number of discharge cells in each of the regions in each subfield; and
correcting the number of sustain pulses to be generated in response to the all-cell light-emitting rate and the partial light-emitting rates in the subfields other than the first subfield and the final subfield of a field.
